(19) United States
(12) Patent Application Publication
(10) Pub. No.: US 2026/0075043 A1
(43) Pub. Date: Mar. 12, 2026

(54) QR-Code-Based Authentication for Closed Mesh Networks

(71) Applicants: Sara Durya, Hillsborough, CA (US); Thomas Craft, Linden, NC (US); Thomas Hines, Benecia, CA (US)

(72) Inventors: Sara Durya, Hillsborough, CA (US); Thomas Craft, Linden, NC (US); Thomas Hines, Benecia, CA (US)

(21) Appl. No.: 19/334,871

(22) Filed: Sep. 20, 2025

Related U.S. Application Data
(63) Continuation-in-part of application No. 18/379,113, filed on Oct. 11, 2023, now Pat. No. 12,531,836.

(51) Int. Cl. H04L 9/40

(52) U.S. Cl. CPC H04L 63/0428; H04L 63/0838; H04L 63/0846; H04L 63/10

(57) ABSTRACT

A method for secure onboarding to a closed mesh network in which a camera-equipped device scans a QR code embedded in a durable physical carrier (e.g., adhesive bandages, photographs, ID cards) to extract an access credential, configuration profile, or secure URL that automatically configures the device for network access, authenticates the device to the mesh without manual credential entry or transmission of plaintext credentials over insecure channels, and establishes end-to-end encrypted communications between network nodes; the method supports cryptographically random, single-use or time-limited credentials with periodic refresh to prevent replay, encoding of VPN/WireGuard or proprietary configuration profiles, substantially real-time onboarding (e.g., under five seconds), optional multi-factor verification (biometric or PIN), immediate initiation of secure messaging, voice/video or data sessions upon onboarding, audit logging for compliance and revocation based on detected unauthorized activity, and covert or overt embedding of QR codes in environment-resistant carriers for emergency, disaster response, first responder, or covert deployment, with the QR code rendered unreadable or deactivated after successful onboarding to prevent credential reuse.

This application is a continuation in part of application Ser. No. 18/379,113 which is a Continuation of Ser. No. 15/433,999, which is a Continuation of Ser. No. 15/051,626 which claims priority from provisional application 62/133,972 filed Mar. 16, 2015, the contents of which are incorporated by reference.

### BACKGROUND OF THE INVENTION

Closed mesh networks—self-configuring groups of devices that route traffic peer-to-peer without reliance on centralized infrastructure—are increasingly deployed in industrial, residential, and tactical settings where availability, resilience, and local control are paramount. Securing such networks presents distinctive challenges: devices must be authenticated and provisioned with cryptographic credentials across potentially constrained user interfaces; key distribution and access policies must scale to many nodes while preventing unauthorized joining or lateral movement; and deployments often operate in air-gapped or intermittently connected environments that preclude reliance on cloud-based identity services. Common onboarding methods—manual entry of passwords or pre-shared keys, temporary access points, or centralized provisioning servers—can be error-prone, cumbersome, and single points of failure. QR codes and other machine-readable tokens are already used in IoT provisioning because they can convey structured credential data quickly and support out-of-band transfer, but their practical use raises concerns about secure binding to physical devices, resistance to cloning or replay, and integration with robust access-control and lifecycle management in closed meshes.

### SUMMARY OF THE INVENTION

In one aspect, a method for providing secure access to a closed mesh network comprises embedding a Quick Response code into a physical carrier object. The Quick Response code is scanned with a device equipped with a camera. The method includes extracting from the Quick Response code an access credential, a configuration profile, or a secure Uniform Resource Locator. The device is automatically configured for secure network access using the extracted information. The device is authenticated with the mesh network based on the extracted credential. End-to-end encryption is established between network nodes without manual credential entry.

Advantages of one implementation may include one or more of the following:
Fast, low-friction onboarding: devices can be provisioned by scanning a QR code rather than manual entry of long passwords or configuration strings.
Offline/air-gapped operation: provisioning and authentication can occur without cloud connectivity because credentials and configuration are delivered out-of-band on the physical carrier.
Strong cryptographic binding: QR payloads can include signed credentials or public keys that cryptographically bind the credential to the intended device or identity, reducing risk of spoofing.
Resistance to replay/cloning: use of signed, time-limited, one-time, or device-specific tokens and physical anti-tamper features makes casual cloning or replay attacks difficult.
Physical possession as a factor: the physical carrier provides an out-of-band possession factor that complements cryptographic authentication to limit unauthorized joins.
Tamper-evidence and provenance: carrier materials, tamper seals, holograms, microprint, or embedded PUFs can provide visible or verifiable evidence of tampering or origin.
Minimal user interface requirements: suitable for devices with constrained or no UI because configuration is performed automatically from the scanned data.
Scalable provisioning and lifecycle management: supports bulk or per-device provisioning, role/policy assignments, certificate issuance, and staged deployment across many nodes.
Fine-grained access control: configuration profiles and credentials delivered in the QR can encode roles, capabilities, or network slices to limit lateral movement.
Automatic secure connectivity: extracted credentials enable immediate mutual authentication and establishment of end-to-end encrypted channels (e.g., TLS, IPSec, application layer).
Intermittent-connectivity resilience: devices can bootstrap with local configuration and later renew or revoke credentials when connectivity resumes.
Reduced single points of failure: eliminates dependence on a central provisioning server at startup, improving resilience in tactical or austere environments.
Auditability and accountability: QR payloads can include identifiers and signed audit metadata to support logging, forensic analysis, and supply-chain tracking.
Support for constrained devices and protocols: payloads can carry compact formats, short-lived keys, or pointers to lightweight enrollment procedures suitable for IoT.
Compatibility with standard security infrastructures: integrates with PKI, certificate authorities, secure elements/TPMs, and standard enrollment protocols.
Support for staged or conditional provisioning: QR data can instruct devices to request additional credentials, perform attestation, or await approval before full network access.
Easy revocation and re-provisioning: designs can use short-lived credentials or link QR codes to revocable records so lost/stolen carriers can be disabled without re-imaging devices.
Local bootstrap via secure URL: embedded secure URLs can point to on-premise configuration services or one-time endpoints to facilitate trusted initial exchange.
Reduced human error and training costs: automated parsing and configuration lower operator mistakes and speed deployments.
Cost effectiveness and deployability: printed carriers are inexpensive to produce and distribute, and can be integrated into manufacturing or field kits.
Enhanced supply-chain security: carriers issued at manufacture or staging can be cryptographically bound to device serials to detect substitution or tampering.
Multi-factor and multi-channel options: QR scanning can be paired with PINs, biometric checks, or NFC to increase assurance where needed.
Selective disclosure and privacy controls: QR payloads can be constructed to reveal only necessary configuration attributes, minimizing exposure of sensitive data.
Rapid recovery and field replacement: lost devices or carriers can be reissued and re-provisioned quickly using the same out-of-band process.
Improved user experience in constrained environments: suitable for residential, industrial, and tactical deployments where simplicity, speed, and security are all required.

### BRIEF DESCRIPTION OF DRAWINGS

FIG. 1 illustrates a flowchart for QR-code-based secure onboarding and authentication in a closed mesh network, progressing from embedding and scanning a QR code to device configuration, authentication, and end-to-end encryption.

FIG. 2A illustrates n exemplary client-server system.

FIG. 2B illustrates networks with multiple devices connecting to a cloud server.

FIG. 3 illustrates the concept of a group of devices operating as a cloud according to an exemplary embodiment.

FIG. 4 illustrates a simplified network formed between a publisher device and member devices according to an exemplary embodiment.

FIG. 5 illustrates and exemplary communication paths between member devices, a publisher device, and a sever.

FIG. 6 illustrates a network where the publisher device, member devise and a sever form a closed cloud.

FIG. 7 illustrates a block diagram of the applications that may be involved in a private network formed between devices.

FIG. 8 illustrates a flow chart illustrating some steps in creating a private network of devices according to an exemplary embodiment.

### DETAILED DESCRIPTION OF THE INVENTION

A system is disclosed that provides secure, user-friendly access to a closed mesh network using embedded QR codes. The system is designed to facilitate rapid, frictionless onboarding of authorized users or devices into a secure communications environment. QR codes are embedded into physical objects (e.g., adhesive bandages, photographs, ID cards, or other carriers) for discreet and durable distribution. These QR codes may be overt or covert, depending on operational requirements. The authorized user scans the QR code using a standard camera-equipped device (e.g., smartphone, tablet, or specialized hardware). The QR code encodes a unique, session-specific access credential, configuration profile, or secure URL. When scanned, this information is used to:
Automatically configure the device for network access (e.g., import VPN, WireGuard, or proprietary mesh network settings).
Authenticate the user/device with the closed mesh network without manual entry of credentials.
Optionally, initiate secure communications (e.g., launch a secure messaging app, encrypted voice/video session, or data transfer).

All access credentials are generated with cryptographic randomness and may be single-use or time-limited. No sensitive data is exposed in plaintext during the onboarding process. End-to-end encryption is established from the device at the moment of onboarding.

The QR code onboarding mechanism is designed to interoperate seamlessly with the patented closed mesh network architecture. The mesh network recognizes and authenticates new nodes/devices via the credentials or tokens delivered through the QR code scan, ensuring only authorized participants can join.

Use Cases include one or more of the following:
Emergency or covert field deployment: QR codes can be embedded in easily concealable objects, allowing operatives to gain immediate access to secure communications without prior device preparation.
Physical access control: QR codes can be used as part of multi-factor authentication for entry to secure areas or systems.
Rapid disaster response: First responders can be issued QR codes to join secure ad-hoc networks in the field.

This system provides a robust, flexible, and highly secure method for granting access to a closed mesh network via QR code, supporting a wide range of operational and commercial scenarios. The approach leverages the physical distribution of QR codes and strong cryptographic onboarding to extend the security and usability of the mesh network described in the original patent. Advantages may include:
Speed: Zero-configuration onboarding—users gain access in seconds with a single scan.
Security: Eliminates the need to transmit or enter sensitive credentials over insecure channels.
Flexibility: QR codes can be distributed in any physical form and can encode any network access protocol (VPN, mesh, proprietary).
Auditability: Each QR code scan can be logged and monitored for security and compliance.

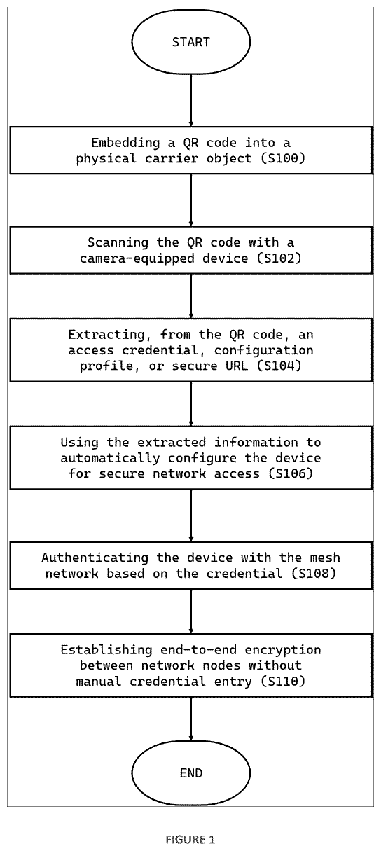

In FIG. 1, a method for providing secure access to a closed mesh network comprises embedding a Quick Response code into a physical carrier object, scanning the Quick Response code with a camera-equipped device, extracting from the Quick Response code an access credential, a configuration profile, or a secure Uniform Resource Locator, automatically configuring the device for secure network access using the extracted information, authenticating the device with the mesh network based on the extracted credential, and establishing end-to-end encryption between network nodes without manual credential entry. The automatically configured settings include networking parameters, cryptographic keys, or pointers to provisioning services, and the authentication employs the extracted credential to obtain or validate node identity prior to permitting network access.

Embedding a QR code into a physical carrier object S100 refers to generating or printing a machine-readable Quick Response code and affixing, imprinting, or otherwise incorporating that code onto or into a tangible medium such that the code is recoverable by a camera-equipped device for subsequent scanning and decoding.

Step S102, labeled “Scanning the QR code with a camera-equipped device,” involves positioning and operating a camera-equipped device to capture image data of the Quick Response code on the physical carrier object, performing image acquisition and any needed image processing to detect and isolate the Quick Response code, decoding the captured code to obtain encoded data, and delivering the decoded data to the device's configuration and authentication procedures for subsequent automatic configuration and network authentication.

Step S104, titled “Extracting, from the QR code, an access credential, configuration profile, or secure URL,” involves decoding the QR code payload and parsing the encoded data to identify one or more of an access credential, a configuration profile, or a secure Uniform Resource Locator. The extraction process can include integrity checks and validation of payload metadata, decryption of encrypted elements when appropriate, and selection of the specific credential or profile fields required for subsequent provisioning. The extracted access credential can comprise, for example, an authentication token, certificate data, or a keying material; the configuration profile can include network parameters and provisioning instructions; and the secure URL can direct the device to a protected provisioning endpoint for retrieval of additional configuration or credentials.

Following extraction, the device is automatically configured using the obtained information to establish secure connectivity parameters and any required provisioning profiles. The device is authenticated to the mesh network using the extracted credential, and, upon successful authentication, end-to-end encryption is established among network nodes to protect communications without requiring manual entry of credentials by the user.

The reference label “Using the extracted information to automatically configure the device for secure network access S106” denotes a process in which the device parses and validates data extracted from the QR code, applies the supplied configuration profile or resolves the secure URL to retrieve configuration data, and installs or provisions required cryptographic artifacts and network parameters into the device's network stack and secure storage. S106 includes configuring interface settings, enabling appropriate authentication modules, setting policy and protocol parameters, and initiating any client-side services necessary to establish secure connectivity; these actions are performed automatically and without manual credential entry, and include integrity checks, status reporting, and preparation for subsequent authentication and encryption steps.

Step S108, identified herein as “Authenticating the device with the mesh network based on the credential,” refers to the process by which the device presents the extracted credential to one or more authenticating entities within the mesh network and is verified according to the network's authentication protocol. In S108 the device's presented credential is validated against stored or dynamically obtained authentication data, the device's identity is confirmed, and any authorization attributes associated with the credential are evaluated to establish the device's permitted level of network participation.

Following successful authentication under S108, the method proceeds to establish end-to-end encryption between network nodes so that data exchanged among authorized nodes is protected without requiring the user to manually enter credentials. The automatic configuration and authentication sequence enables secure provisioning and initiation of encrypted communication channels among mesh nodes while minimizing user interaction.

Establishing end-to-end encryption between network nodes without manual credential entry S110 is performed after successful device authentication by negotiating cryptographic material and establishing secure communication channels between nodes using the authenticated credential and any provisioning data contained in the configuration profile or secure URL. In S110, session keys or node-specific ephemeral keys are generated and exchanged, cryptographic parameters and trust anchors are selected or validated according to the extracted profile, and mutual verification of credentials is performed so that encrypted communications are maintained between network nodes without further user intervention.

A closed mesh network is provisioned using a physical carrier object that bears a machine-readable two-dimensional barcode, such as a QR code, printed, embossed, or otherwise embedded into the carrier object. The carrier object can take the form of a label, sticker, card, wristband, tag, product packaging, enclosure panel, or tamper-evident seal. The QR code can be printed directly on the carrier or encapsulated under a protective substrate, and can include overt or covert features (microprinting, UV ink, holographic overlays) to reduce cloning and indicate authenticity (S100).

A camera-equipped device, for example a smartphone, tablet, laptop with camera, or an Internet of Things (IoT) appliance with an integrated imaging sensor, captures an image of the QR code. A provisioning application or an operating system network manager module decodes the imaged code and, if necessary, performs image preprocessing (deskew, contrast normalization, error correction using Reed-Solomon) and optical character recognition to extract the encoded payload (S102). The application can operate in an out-of-band trusted context such as within a secure provisioning app signed by the mesh network operator or as an OS-level provisioning service to prevent spoofing by untrusted apps.

The decoded payload of the QR code contains one or more data elements that enable secure, automatic onboarding. Examples of encoded elements include an access credential (for example a signed device certificate, a time-limited token, or a symmetric provisioning key), a configuration profile (for example network SSID, channel lists, routing parameters, mesh role assignments, preferred firmware update server addresses), and/or a secure URL pointing to a provisioning service where additional configuration material can be retrieved over a secure channel (S104). The payload is preferably formatted in a machine-readable structured representation (for example JSON or CBOR) and is signed and/or encrypted. The payload includes metadata such as version, validity period, usage constraints (for example single-use or multi-use), a timestamp or nonce to prevent replay attacks, and an identifier that binds the payload to a particular device model or serial number if required.

To protect against cloning and eavesdropping, the QR payload can be cryptographically protected. One approach is to include a signed statement from a trusted certificate authority or from the network operator; the provisioning application verifies the signature against embedded or pre-provisioned trust anchors. Another approach is to encrypt the QR payload using a key known only to the provisioning service; the secure URL within the payload can then be used by the device to retrieve a device-specific credential after mutually authenticating to the provisioning server. Ephemeral, single-use tokens encoded in the QR code are issued by the operator and tied to a single provisioning session; the provisioning server marks such tokens as used upon successful provisioning, preventing reuse.

Upon successfully extracting and authenticating the payload, the provisioning application uses the extracted information to automatically configure the device's network stack and security settings without requiring manual credential entry by the user (S106). Automatic configuration can include installing a network profile containing SSID and mesh identifier, configuring layer 2 and layer 3 parameters, importing a device certificate or private key into a secure element or trusted execution environment, enabling specific cryptographic algorithms (for example curve25519 or NIST P-256 for key exchange and AES-GCM or ChaCha20-Poly1305 for authenticated encryption), and setting up policies for route advertisement and neighbor discovery. Where the payload provides a secure URL rather than full credentials, the device establishes a TLS-mutual-authenticated session to the provisioning service and downloads device-specific credentials and configuration policies. Device-side processes validate all downloaded artifacts, check certificate chains, verify timestamps, and enforce constraints encoded in the profile.

Authentication of the device with the closed mesh network is performed based on the credential obtained from the QR payload or from the provisioning server. Authentication mechanisms supported include certificate-based mutual TLS (using X.509 certificates), 802.1X/EAP methods, token-based OAuth flows to a gateway or controller, or a public-key-based bootstrap followed by an authenticated key exchange. For certificate-based approaches, the device presents its device certificate during a TLS handshake or EAP exchange; the receiving mesh node or controller validates the certificate chain and checks revocation and status information against a Certificate Revocation List (CRL) or via Online Certificate Status Protocol (OCSP). For token-based approaches, the token is presented to a mesh controller which maps the token to a device identity and grants network credentials. Authentication logic enforces policy associating device identity with permitted roles, quality-of-service tags, and access control lists (S108).

Once authenticated, peer nodes establish end-to-end encrypted channels without requiring manual credential entry by users or administrators. End-to-end encryption is achieved by combining authenticated key exchange protocols with per-session ephemeral keys to provide forward secrecy. Nodes use standard secure transport protocols such as TLS/DTLS or modern noise-framework constructions to negotiate session keys; alternatively, application-level encryption frameworks—for example secure messaging protocols or a WireGuard-like tunnel using Curve25519 for key agreement and ChaCha20-Poly1305 for encryption—are instantiated using credentials provisioned during onboarding. The provisioning process is configured to distribute or enable retrieval of group encryption keys, per-peer public keys, or trust anchors used to authenticate ephemeral key exchanges. Rekeying schedules, key lifetimes, and algorithms are configured by the profile to satisfy confidentiality and performance requirements. These operations are performed by the device automatically as part of the onboarding and join procedures, eliminating the need for manual entry of passphrases or keys (S110).

The system supports a range of QR payload complexity to balance usability and operational security. A minimal payload may contain only a secure URL and a temporary access token; the device then retrieves configuration and credentials dynamically. A more comprehensive payload contains a complete configuration profile and a signed device certificate to enable offline provisioning when network connectivity to the provisioning server is not immediately available. The provisioning application validates all received artifacts in accordance with the policy embedded in the payload and the operator's security requirements.

User interactions during the provisioning flow are minimized. When user consent is required (for example, to allow a new device to join a corporate mesh or to upload telemetry), the provisioning application displays a clear, concise confirmation dialog indicating the identity of the mesh network and the privileges to be granted. The process requires local presence confirmation, such as sensing proximity to the carrier object or requiring the user to press a physical button on the device being provisioned, to mitigate remote attacks that attempt to misuse visible QR codes.

Operational considerations include support for multiple profiles and role-based provisioning, enabling a single carrier object to contain multiple provisioning tokens or to refer to a provisioning server that yields different credentials based on the credential presented. The provisioning system can support staged onboarding where the device first joins a controlled onboarding VLAN with limited access, completes firmware and policy updates, and only then is promoted to full mesh membership. Audit records of provisioning events are stored securely by the provisioning server and by participating mesh controllers; logs record the QR token identifier, timestamp, provisioning server responses, and the resulting device identity for later forensic analysis or compliance reporting.

The method accommodates variations in mesh architectures. In centrally managed meshes, a provisioning controller coordinates node authentication, issues certificates, manages revocation lists, and propagates group keys. In more decentralized or zero-touch meshes, devices use the provisioning credentials to establish mutual trust directly with neighboring nodes and perform a distributed key agreement to derive pairwise or group encryption keys. Routing and neighbor discovery protocols are augmented to use authenticated node identities derived from the provisioning credential so that routing decisions are constrained by security policy.

Error handling and recovery mechanisms are provided. If QR decoding fails due to print degradation or camera limitations, the provisioning app offers retry guidance (lighting, focus) and allows manual entry of an alphanumeric provisioning code printed alongside the QR code. If provisioning fails because a token is expired or already used, the provisioning app reports the reason and provides instructions for obtaining a replacement carrier object or contacting the operator. Revocation and recovery processes enable operators to revoke compromised credentials; devices that detect revocation signals refuse to participate in the mesh until re-provisioned through an authorized workflow.

Privacy and security best practices are implemented. The QR payload includes only the minimum information required to provision the device; personally identifiable information is excluded unless explicitly necessary and consented to. All communications with the provisioning server use mutually authenticated, integrity-protected transport. Cryptographic algorithms and key sizes are configurable to align with contemporary security recommendations, and operators can enforce algorithm policies via the configuration profile. Optional privacy-enhancing techniques, such as ephemeral pseudonymous certificates or per-session identifiers, are supported to reduce persistent tracking risks.

Implementation can be realized via software modules that integrate with device firmware and operating systems. A provisioning agent handles QR decoding, payload parsing, cryptographic verification, secure storage of keys, and network stack configuration. The provisioning server implements token issuance, certificate authority services, configuration profiles, and audit logging. Interfaces between the provisioning agent and platform keystores or secure elements are defined to ensure keys are generated or imported into hardware-backed stores rather than being exposed in software. The design supports firmware-level provisioning for headless devices by coupling a camera or an external imaging accessory to an initial provisioning host that performs credential injection over a secure local channel.

Variants of the described method include alternative physical carriers (for example NFC tags or Bluetooth beacons carrying the same secure payload), multi-factor onboarding in which the QR-based credential is combined with a second factor (for example an operator-provided password or physical button), and hierarchical provisioning in which a master carrier provisions a local provisioning server that then issues time-limited credentials to multiple devices in a batch. The method can be extended to support staged re-provisioning, periodic credential rotation, and integration with enterprise identity and access management systems.

A physical carrier object is prepared by embedding a machine-readable two-dimensional barcode, for example a QR code, into or onto the carrier in accordance with step S100. The QR code payload includes an access credential, a configuration profile, and/or a secure URL (collectively referred to herein as an access token). In some embodiments the payload further contains metadata such as a token identifier, an issuance timestamp, an expiration timestamp, a nonce or sequence number, an issuer identifier, the intended network or service identifier (for example, a mesh network identifier), and a digital signature or message authentication code (MAC) computed by a network authority. The QR code can be printed, engraved, or otherwise applied to the carrier object and provided with tamper-evident features or overt and covert markings to reduce cloning risk.

Access credentials are generated using cryptographic randomness before being embedded in the QR code. A cryptographically secure pseudo-random number generator (CSPRNG) or a hardware random number generator (HRNG) is used to produce sufficient entropy for the credential and any associated keys or nonces. In some embodiments the credential is a single-use token produced by concatenating a random nonce with a token identifier and then applying a digital signature or message authentication code (MAC) over the concatenated value using a network authority private key or a symmetric key. In other embodiments the credential is a temporary key or certificate with a finite lifetime expressed as an expiration timestamp. Single-use behavior is enforced by including a unique identifier for the token and by maintaining state at the authentication service to mark tokens as consumed upon successful authentication, preventing reuse. Time-limited behavior is enforced by embedding an explicit expiry value in the token payload and by requiring the authentication service to validate that the current time falls within the token's validity window before granting access.

The generated credential can take various forms without departing from the scope of one implementation. Representative forms include a signed JSON Web Token (JWT) containing claims for network access; an HMAC-protected opaque token with an associated server-side lookup table; an X.509 certificate or certificate-like object with a limited-duration lifetime and restricted scope; or an encrypted payload that requires a network-side private key for decryption. When a symmetric approach is used, the token payload can include an HMAC computed using a server-side secret; when asymmetric cryptography is used, the payload is signed with a private key whose corresponding public key is distributed to authentication points in the mesh network. Key lengths, algorithms, and parameters are selected according to current cryptographic best practices (for example, AES-128 or AES-256 for symmetric protection, HMAC-SHA-256 for MACs, and elliptic-curve keys of adequate size such as P-256 for public-key operations), and embodiments are configured to be algorithm-agile so that new algorithms can be adopted as standards evolve.

A user or installer scans the QR code with a camera-equipped device, such as a smartphone, tablet, or dedicated provisioning tool, in accordance with step S102. The scanning application parses the QR payload and extracts the access token and any included configuration profile or secure URL in accordance with step S104. The scanning application validates the structure and cryptographic integrity of the token where feasible on-device; for example, it verifies a signature over the token using a cached or embedded public key for the issuer, verifies a MAC if a shared secret is available to the device, or checks that the token expiration timestamp has not elapsed. When on-device verification is not possible or desirable, the application forwards the token in a TLS-protected request to a network provisioning server or gateway for validation.

Single-use and time-limited properties are enforced through a combination of token design, server-side state, and validation rules. For single-use tokens, the provisioning service records the token identifier in a usage ledger when the token is first accepted; subsequent attempts to use the same identifier are rejected. To protect against race conditions and replay attacks, ledger operations are performed atomically and include counters or sequence numbers and, optionally, one-time counters that bind the token to a specific authentication session. For time-limited tokens, the provisioning service compares an issuance or expiry timestamp in the token against a trusted clock. In some embodiments the system supports a clock tolerance window to accommodate devices with inaccurate clocks; in such cases additional freshness mechanisms such as brief nonces, server-issued challenges, or a two-step validation handshake further mitigate replay risk.

Implementation details vary across embodiments. The QR generation workflow can be integrated into an administrative console where network operators specify policies (for example, single-use or time-limited, allowed device classes, scope of access). The backend generates tokens accordingly, stores token metadata in a secure database, and prints or otherwise supplies physical carriers. The scanning application can be a dedicated provisioning app, or its functionality can be integrated into existing device management or network management applications. On the network side, authentication and provisioning services expose APIs for token validation, credential issuance, and revocation. Mesh nodes and gateways implement validation logic and secure key management facilities to accept only credentials issued by trusted provisioning authorities.

Various additional safeguards and optional features are contemplated. Revocation mechanisms permit invalidating tokens prior to their natural expiry; revocation is accomplished by maintaining a revocation list or by using limited token lifetimes combined with periodic renewals. Rate limiting, anomaly detection, and geo-fencing are employed during provisioning to detect and mitigate suspicious activity. For resource-constrained devices, lightweight cryptography and compact token formats are supported. For higher-assurance environments, multi-factor provisioning is implemented by requiring the scanned QR token in combination with a user authentication factor or possession of a secondary hardware token.

The foregoing description contemplates numerous substitutions, modifications and variations. For example, the QR code can be replaced by other machine-readable formats (such as NFC tags or barcodes) without changing the underlying cryptographic token generation and validation techniques; server-side validation can be performed synchronously during scanning or deferred to a later enrollment step; and the single-use and time-limited token properties can be combined or augmented with additional constraints such as scope-limited permissions, device binding, or hierarchical delegation. These and other embodiments are within the scope of one implementation as claimed.

For adhesive bandages, the QR code is printed using a UV-fluorescent or IR-absorbing ink onto the fabric or polymer backing and then covered with a translucent protective film so the printed matrix is hidden from ambient illumination; alternatively, the matrix is formed by selectively varying the weave density or micro-perforations of the bandage backing.

For photographs, the QR code is encoded by modifying the halftone dot pattern or by introducing a microdot pattern into an image border or a lamination layer; the visual alterations are constrained to spatial frequencies outside the normal perceptual bandwidth so as to preserve the image appearance.

For identification cards, the QR code is integrated into a holographic laminate, laser-etched beneath a clear PVC surface, printed as microtext in a ghost image area, or embedded within a multi-layer card such that the QR modules become detectable only under UV illumination or through polarization filtering.

The covert embedding further includes tamper-evident structures, such as an adhesive seal that irreversibly changes appearance if removed, or a layered construction that destroys the code if delaminated, thereby providing physical protection for the encoded credential.

During provisioning, a camera-equipped device captures an image of the carrier object and detects the covert QR code (S102) using an application configured to apply multiple imaging modalities. The application can automatically toggle device illumination between white, UV, and near-IR illumination, or instruct the user to position the device relative to an auxiliary illumination source; it can also switch internal camera filters or process multiple frames to isolate the covert signal. Image preprocessing includes denoising, contrast enhancement, spectral separation, demosaicing, perspective correction, and registration against expected alignment markers embedded in the carrier. The application also applies demodulation algorithms to recover QR module information from modified halftone or microdot patterns, including frequency-domain filtering to separate the covert spatial frequencies from the visible content.

Security and operational safeguards are incorporated throughout. The covert QR payload includes nonce values, expiration timestamps, and usage counters to limit replay and cloning; the payload is signed and, when required, encrypted to prevent credential disclosure if the carrier is lost. The issuance process links a physical carrier to a registration event, and the management backend supports revocation and status queries keyed by identifiers embedded in the code. Manufacturing controls ensure print fidelity and placement accuracy: recommended module sizes, ink formulations, and layer thicknesses are selected to match the intended imaging modality and the resolution of typical camera-equipped devices; error-correction settings are configured to tolerate wear and partial occlusion typical of adhesive bandages and cards. Alternative embodiments provide dual-layer encoding in which a visually unobtrusive visible code is supplemented by an invisible layer that carries sensitive credentials; the visible layer acts as an index to a backend that verifies possession of the physical carrier prior to releasing network credentials. Applications include rapid, minimal-contact enrollment of medical devices via bandage carriers, secure onboarding of personal devices from identity cards, and authenticated device activation from a printed photograph used as a trusted artifact. The described methods and carrier constructions enable secure provisioning and end-to-end encrypted communication without requiring manual entry of network credentials.

The detailed description provides one or more embodiments in which a camera-equipped device is automatically provisioned for secure network access by scanning a QR code embedded in a physical carrier object, at S100, the QR code being physically embedded into carrier objects such as adhesive labels, laminated cards, key fobs, wristbands, product packaging, or printed tags. The QR code payload can directly contain a fully self-contained configuration profile, or a compact bootstrapping token or secure URL that references a configuration profile retrievable from a provisioning server. The configuration profile encoded in the QR code is expressible in a compact, machine-readable container such as JSON or CBOR, optionally base64- or URL-compatible-base64-encoded to conform to QR encoding constraints. Example fields for a WireGuard profile include keys and network parameters such as: interface: {private_key: <base64>, address: <CIDR>, dns: <IP-list>, mtu: <value>}, peer: {public_key: <base64>, endpoint: <host:port>, allowed_ips: <CIDR-list>, persistent_keepalive: <seconds>}. Example fields for a VPN profile include: vpn_type: <IKEv2/OpenVPN/Proprietary>, auth: {cert: <PEM-or-base64>, pre_shared_key: <base64-or-hash>, username_toke>: <token>}, connection: {server: <host:port>, cipher_suite: <string>, mtu: <value>, routes: <CIDR-list>}. For proprietary mesh configuration profiles the payload can include mesh-specific parameters such as node_id, bootstrap_peers, discovery_seeds, routing_policy, uid, and cryptographic material required by the mesh protocol (for example Noise or other asymmetric keys and protocol version identifiers). The QR payload can also include metadata fields such as issuance_timestamp, expiry_timestamp, profile_version, and an issuer identifier.

The configuration profile can be self-signed or signed by a trusted authority. The device verifies signatures and checks field integrity before applying any network configuration. Signature verification uses standard public-key signatures (for example ECDSA or Ed25519) with a certificate chain rooted at the provisioning authority. To avoid exposing private provisioning keys, the QR issuer signs the profile at issuance and the device verifies the signature against a locally stored or operator-discoverable public key. In another embodiment the QR payload contains only a fingerprint or hash of the full profile and a secure URL; the hash is used to validate the retrieved profile.

Upon successful extraction and verification of the profile (S104), the device automatically configures local networking stacks and system components (S106) without manual credential entry. For WireGuard embodiments this includes creating an interface, writing the private_key to the device's secure key store (for example TPM, Secure Enclave, or Keystore), applying the IP address and routing rules, configuring DNS, and adding the peer entry with public_key, endpoint, allowed_ips, and persistent_keepalive. For VPN embodiments, this includes provisioning the appropriate OS VPN client or embedded VPN daemon with certificates, pre-shared keys, server endpoints, chosen cipher suites, and split-tunneling rules where applicable. For proprietary mesh networks the device configures the mesh daemon with node identifiers, neighbor discovery seeds, transport parameters (UDP/TCP ports), and the cryptographic identity materials.

The device's provisioning logic can adopt different strategies for private key management. In one approach the QR profile contains the private key material for the device; the device stores the private key into a hardware-backed key store and marks it non-exportable. In an alternative, more secure approach the device generates a fresh ephemeral or persistent key pair on-device at first boot or during scanning; the device includes the generated public key in a one-shot registration request to a provisioning server by either encoding the public key into a secure retrieval operation or by showing the public key to the operator for manual pairing. The provisioning server binds the generated public key to a peer configuration and returns the peer side configuration signed for acceptance by the mesh controller. A hybrid approach encodes a unique per-device provisioning token in the QR that the device uses together with its generated public key to authenticate to the provisioning endpoint and obtain the peer configuration.

Authentication of the device to the mesh network occurs at S108 using credentials extracted from the profile. Authentication mechanisms include certificate-based mutual TLS or EAP-TLS for VPNs, and certificate- or public-key-based peer authentication for WireGuard and for proprietary mesh protocols. For WireGuard, the configured public/private key pair serves as the device identity and the peer list contains permitted peer public keys; the WireGuard handshake performs mutual authentication and derives session keys via the protocol's built-in key exchange (the Noise-based pattern in WireGuard). For VPN embodiments, the device presents a client certificate provisioned from the profile or uses a one-time password or pre-shared key included in the profile; the server validates the credential and enrolls the device in the network's access control list. For proprietary meshes, the device executes the mesh-specific handshake and enrollment process using the provided credentials and bootstrap peers.

Automatic establishment of end-to-end encryption between network nodes is accomplished at S110 once the device is authenticated. In WireGuard implementations, the WireGuard handshake produces symmetric session keys used to encrypt traffic between peers; these keys are stored only in volatile memory and are periodically rotated according to configured key-lifetime parameters. In VPN and proprietary mesh implementations, the applied profile configures the cryptographic ciphersuites and key exchange methods (for example IKEv2, TLS 1.3, or a mesh-specific secure channel) to achieve end-to-end confidentiality and integrity. The profile instructs nodes to negotiate perfect forward secrecy using ephemeral key exchange and specifies key rotation policies and automated re-provisioning triggers. Routing policies within the profile restrict traffic so that only authorized peer-to-peer tunnels are established, enabling end-to-end encrypted channels across mesh overlays without operator intervention beyond the initial scan.

The provisioning flow supports both offline and online bootstrapping. Offline bootstrapping employs a QR code that carries a complete profile (optionally encrypted) and all required cryptographic material, enabling the device to configure and authenticate without network retrieval. Online bootstrapping uses a QR code that contains only a secure retrieval URL and an authentication token; this reduces the amount of data encoded in the QR and avoids embedding private keys intended to remain valid for extended periods directly in the printed code. The provisioning application manages device state transitions, error handling, and user prompts. If signature verification fails or profile parameters conflict with device policies, the application rejects the profile and records diagnostic information for operator review.

Mesh topology discovery and peer propagation are automated after provisioning. The profile includes discovery seeds or rendezvous servers that assist the new node in locating peers. Once peers are discovered and authenticated, the mesh routing layer exchanges topology and keying material as permitted by the provisioning policy. To support scaling, the provisioning authority issues per-class templates instead of per-device full profiles; the QR encodes a template identifier and a temporary bootstrap credential that the device uses to request a full, device-specific profile from the provisioning service. The provisioning service enforces policy controls and rate-limiting to mitigate misuse.

Alternative embodiments include embedding multiple QR codes on a single carrier object, each code corresponding to different access roles, networks, or fallback mechanisms. The provisioning application is configured to present a list of detected codes and to allow the user or administrator to select which profile to apply. Logging and audit trails are recorded either locally or on the provisioning server to capture issuance, scan events, profile application, and subsequent authentication attempts. These logs include hashed representations of device identifiers to protect privacy while enabling forensic and operational analysis.

Using the extracted information, the device automatically configures its network interfaces and security stacks (S106) without requiring manual entry by a user. Automatic configuration includes installing an enterprise-style network profile (for example, an EAP-TLS profile), configuring WPA3-Enterprise parameters, provisioning a set of trusted root certificates or certificate authorities, enabling specific mesh networking protocols, and setting firewall or routing rules suitable for the intended services. The configuration routine is implemented as a privileged system service that writes the configuration atomically and performs sanity checks before activating network interfaces. Where the configuration profile includes service endpoints for messaging or media, the system service pre-populates application configuration stores and registers the service endpoints with an application management framework.

In embodiments further comprising initiation of a secure messaging application, encrypted voice or video session, or data transfer upon network onboarding, the provisioning workflow triggers an application launch and session bootstrap sequence immediately following successful authentication and establishment of cryptographic material. The trigger is a system event emitted by the network configuration service after S108 completes and cryptographic keys are installed. The triggered sequence includes launching a messaging client, initiating an encrypted voice or video call using predefined contacts or service identifiers contained in the configuration profile, or starting a secure file synchronization or data transfer job. The configuration profile includes service identifiers, contact UIDs, conference identifiers, session tokens, and preferred codecs or transport parameters so that the application is able to join or create a secure session with minimal latency.

The automatic initiation sequence is implemented to preserve security and user control. For example, the device is configured to require a contextual policy decision before auto-launching user-visible applications. Policies embedded in the QR payload or stored at the provisioning server can indicate whether auto-launch is allowed, whether user confirmation is required, or whether the trigger is permitted only when certain environmental conditions exist (for example, device locked/unlocked state, presence of a corporate policy flag, or time-of-day constraints). User consent flows can be presented as a one-time consent upon first onboarding or as a per-session confirmation, and the system can provide a notification explaining what is being launched and why.

From a cryptographic perspective, automatic session initiation leverages keys provisioned during onboarding so that the application-level handshake proceeds without additional manual credential entry. For example, an onboarding operation deposits an identity key pair and a temporary application token into a secure element; the messaging client authenticates to the messaging service with the identity key and uses the token to authorize session creation. For encrypted voice and video, the client uses DTLS with the provisioned certificate to establish media security. If the configuration profile includes a pre-shared symmetric session key or a one-time bootstrap symmetric key, that key is used to derive further session keys via a KDF, enabling immediate establishment of end-to-end encrypted channels.

Fallback and error handling are provided in case automatic initiation fails. If the provisioning server or service endpoints are unreachable, the device is configured to queue session initiation requests and retry using exponential backoff policies. If a signature or certificate is invalid or revoked, the device is configured to abort the auto-initiation, notify the user or administrator, and optionally attempt to contact the provisioning gateway for remediation. Revocation mechanisms are supported by the provisioning architecture; for example, the mesh network can distribute a revocation list or use an online status service so that compromised credentials are invalidated and automatic initiation of sessions using revoked credentials is prevented.

Additional embodiments provide privacy-protecting and anti-abuse safeguards. The QR payload can be scoped to limit which services are auto-launched and to restrict the duration of the auto-launch window. Rate-limiting and confirmation thresholds prevent malicious or accidental repeated launches. Attestation data and telemetry from the device are forwarded to an administrative backend to record that an automatic secure session was created, for audit and compliance purposes. Administrative interfaces allow operators to adjust policies that govern whether and how secure messaging, voice/video, or data transfers are initiated automatically upon onboarding.

Alternative implementations vary the locus of control for session initiation. In one alternative, instead of the device autonomously launching applications, the provisioning server sends a push notification to the device after onboarding that contains an encrypted session request; the device validates the request and then launches the appropriate application. In another alternative, the QR code encodes a single-use secure URL that, when accessed by the device, redirects through an identity broker that performs additional checks (for example, multi-factor verification) before returning the final session credentials. These variations permit different trade-offs between immediacy of session start, centralized policy enforcement, and user-in-the-loop security.

The described techniques apply to a wide range of device types and deployment scenarios. In consumer settings, a QR code is printed on product packaging or embedded in a quick-start guide to provide out-of-the-box secure connectivity and an optional welcome secure chat or onboarding call. In enterprise or industrial environments, a QR code is affixed to equipment and associated with role-based profiles so that a technician scanning the code is automatically placed into encrypted maintenance channels with the appropriate service accounts. In each case, automatic initiation of secure messaging, media sessions, or data transfers is tightly coupled to the secure provisioning and authentication flow so that no manual credential entry is required while preserving mechanisms for consent, revocation, and audit.

When a user or installer scans the QR code with a camera-equipped device (S102), the device decodes the payload (S104) and verifies any embedded signatures using the included or pre-provisioned public key of the network authority. Where the payload is encrypted, the device decrypts it using a private key stored securely in the device (for example in a secure element or trusted execution environment) or by deriving a key from locally held material; in such embodiments the QR acts as an out-of-band (OOB) channel to transfer non-replayable tokens or configuration parameters rather than plaintext credentials. In a representative embodiment the QR contains a signed enrollment token and the network authority's public key; the device validates the signature locally, thereby confirming authenticity and integrity of the token before using it to bootstrap further communication. In another embodiment the QR encodes parameters for a password-authenticated key exchange (PAKE) instance (for example SPAKE2 or SRP) together with a salt and iteration count; the PAKE parameters and any limited-entropy secret are combined and used exclusively within a PAKE protocol so that no plaintext secret is transmitted to the authenticating party.

Automatic configuration of the device for secure network access (S106) proceeds using only cryptographically protected exchanges. In one embodiment the device generates an ephemeral asymmetric key pair (for example an elliptic-curve key pair) locally upon extracting the provisioning payload and constructs a certificate signing request (CSR). The device establishes a TLS (or DTLS) session to the indicated secure provisioning endpoint using standard certificate validation and, where required, presents the signed enrollment token as proof of authorization. The token is sent only within an authenticated and encrypted TLS channel, or is used as input to a PAKE exchange that never exposes the token in plaintext over the wire. The provisioning server verifies the token signature and any associated claims, verifies proof-of-possession of the device's private key (for example via the CSR or a challenge-response signed by the device's private key), and issues a device certificate or other credential over the encrypted channel. At no point in this exchange is any plaintext password or raw secret transmitted over an insecure channel; secrets are either transmitted only within TLS/DTLS (or other authenticated encryption tunnels) or never transmitted because they are used only as inputs to key-agreement or zero-knowledge-proof protocols.

Authentication to mesh network nodes (S108) is performed using mutual cryptographic authentication that avoids plaintext credential transmission. In one embodiment the device and an authenticating mesh node perform an authenticated Diffie-Hellman (for example ECDH) key exchange protected by signatures: the device presents the issued device certificate and proves possession of the corresponding private key by signing a server-provided nonce; the authenticating node verifies the certificate chain to the trusted CA and verifies the signature. All verification and proof-of-possession steps occur inside an encrypted channel or as part of a protocol that does not reveal private material. In another embodiment the device and the network employ an EAP method that supports mutual authentication without plaintext credential exposure, such as EAP-TLS (certificate-based) or EAP-pwd/PAKE (password-based authenticated key exchange), where the EAP method is transported only over secure transport layers or uses cryptographic mechanisms that never transmit the password in the clear.

End-to-end encryption between nodes of the mesh network (S110) is established without manual credential entry by employing pairwise or group keying mechanisms derived from cryptographically authenticated exchanges performed during provisioning and authentication. In one embodiment, once the device obtains a certificate from the provisioning server and authenticates to a local mesh gateway, the gateway and the device perform a mutual ECDH to derive session keys for link-layer encryption. For end-to-end encryption across multiple hops in the mesh, nodes exchange signed key-wrapping messages: the originating node generates content-encryption keys (CEKs) and encrypts them to the public keys or certificates of the intended recipient nodes, and those wrapped CEKs are distributed over the mesh; each recipient unwraps the CEK only after verifying the sender's signature and certificate chain. Alternatively, group keying is established by a group key agreement protocol in which membership is authorized by possession of valid certificates issued during the provisioning phase; new group members receive group keys only after proving possession of their private keys and after the group controller verifies their provisioning credentials. In bandwidth-or resource-constrained embodiments, lightweight AEAD schemes (for example AES-GCM or ChaCha20-Poly1305) combined with HKDF-based key derivation from authenticated ECDH outputs are used to provide efficient end-to-end confidentiality and integrity without exposing plaintext credentials at any point.

A variety of cryptographic primitives and standards can be used to realize the above without transmitting plaintext credentials. Asymmetric mechanisms include X.509 certificates and PKI, mutual TLS, signed JWT or signed assertions (for example using RSASSA-PSS, ECDSA), and device attestation (TPM quotes or TEE attestations) where available. Symmetric and password-based mechanisms include PAKE variants (SPAKE2, J-PAKE, SRP) and EAP methods that are specifically designed to avoid password disclosure. All network-facing exchanges that carry authorization material are performed over authenticated and encrypted transports (for example TLS 1.2/1.3 with mutual authentication, DTLS, or equivalent authenticated encryption tunnels), or are designed such that no secret is ever transmitted in the clear (for example zero-knowledge proofs or PAKE). Keys derived from any exchange are generated using standardized KDFs (for example HKDF) with context-specific information and usage labels to prevent key reuse across domains.

The foregoing embodiments illustrate methods whereby a physical QR-based provisioning channel (S100-S104) is leveraged to perform automatic configuration (S106), authenticated attachment to a mesh network (S108), and establishment of end-to-end encrypted communications between nodes (S110) while ensuring that no plaintext credentials are transmitted over insecure channels. Through use of signed, time-limited tokens, authenticated key exchange protocols, TLS/DTLS protected exchanges, PAKE methods, device-bound keys, and secure storage/attestation mechanisms, the system provides secure bootstrap and ongoing authentication without manual credential entry and without exposing plaintext secrets to interception or replay.
S100 Embedding a QR code into a physical carrier object
S102 Scanning the QR code with a camera-equipped device
S104 Extracting, from the QR code, an access credential, configuration profile, or secure URL
S106 Using the extracted information to automatically configure the device for secure network access
S108 Authenticating the device with the mesh network based on the credential
S110 Establishing end-to-end encryption between network nodes without manual credential entry

Immediately upon extraction, a provisioning agent on the device is launched automatically or invoked by the OS to act on the extracted information. The provisioning agent performs automatic configuration of the device for secure network access (S106). Automatic configuration includes populating wireless network identifiers (SSID), security type (e.g., WPA2/WPA3), provisioning of EAP or PSK parameters, application of network profile settings, and optional registration of device metadata with the provisioning backend. To minimize user interaction and achieve rapid completion, the provisioning agent performs these actions without manual entry; operating system mechanisms such as deep-linking, Intent-handling, universal links, or application relaunching are used so that no separate user navigation or credential transcription is required.

To ensure onboarding completes in under five seconds after scanning the QR code, embodiments implement time-saving measures at each stage. The QR payload is constrained in size and complexity so that decoding and parsing occur within tens to a few hundred milliseconds. The provisioning agent is pre-installed and resident, or is launched via an OS intent designed to minimize startup latency so that agent initialization is reduced. Network discovery and join procedures are simplified by encoding network topology or the target gateway in the QR or token, enabling the device to identify the appropriate mesh join point immediately rather than performing multi-second discovery scans.

Authentication protocols are selected or configured to complete with a minimal number of round trips: for example, encoding a pre-shared credential in the QR permits a single-round-trip authentication to the mesh gateway; alternatively, provisioning can use TLS 1.3 0-RTT or a lightweight Noise-based handshake to shorten transaction time. Hardware cryptographic acceleration on the device and on gateway nodes is leveraged to accelerate key derivation and signature verification. In one embodiment, typical time allocations include: QR decode and parse under 200 ms, agent launch and local configuration under 500 ms, network join and authentication under 2,500 ms, and end-to-end key establishment under 1,000 ms, yielding a cumulative completion time under five seconds. Other allocations are possible; the listed figures illustrate how the under-five-seconds objective can be achieved.

Alternative embodiments provide additional acceleration mechanisms. For networks requiring IEEE 802.11 association, the QR also contains the SSID and an automatable AP-mode join method such as SoftAP-based provisioning, in which the gateway temporarily exposes an unencrypted or minimally encrypted AP for the device to exchange credentials; this approach is arranged to complete within the overall five-second target by minimizing discovery and using ephemeral credentials. Another embodiment encodes Bluetooth OOB pairing data in the QR so the device can pair with the gateway over BLE and complete provisioning over a reduced-latency BLE transport; the BLE pairing and provisioning protocol is selected to finish with few round trips. Yet another embodiment embeds a minimal bootstrap routine in the QR that instructs the device to launch a preinstalled provisioning app, which then performs a single secure handshake with the gateway using pre-provisioned material.

Robustness and security measures are included to handle adverse conditions while preserving the time objective. If an initial decode fails due to poor lighting or camera motion, the device is configured to provide a brief, single-step retry prompt; to avoid extended delay, the provisioning agent is configured to let the user select an alternative on-screen capture or tap a provided NFC tag on the carrier as an alternate out-of-band (OOB) channel. If network authentication fails due to token expiration, fallback logic permits a fast re-request of a new token by issuing a minimal, authenticated call to the backend, and prompts the user only when automated recovery cannot be performed. All communications involving credential exchange or configuration retrieval are protected by cryptographic integrity checks and by limiting token lifetimes to a brief window to mitigate replay attacks.

The disclosed onboarding flow is extensible to support multiple mesh topologies and credential types. For example, a QR code can encode a provisioning profile that triggers role-based configuration at the gateway, enabling different device classes to receive distinct network privileges. The method supports remote revocation and re-provisioning by associating the QR-provided credential with a limited validity period and with a backend-managed revocation mechanism. Devices seeking to renew credentials can undergo a similarly optimized renewal flow to preserve rapid re-onboarding.

Any of the above-described features can be combined in various permutations to achieve fast, secure onboarding with minimal user interaction that completes in less than five seconds after scanning the QR code, while providing authenticated admission to a mesh network and establishing end-to-end encrypted communication channels among network nodes without requiring manual credential entry.

In one or more embodiments, each QR code scan event is recorded in a secure, tamper-evident audit log that supports accountability, forensic analysis, and regulatory compliance. A scan event is generated when a camera-equipped device performs the scanning operation (S102) of a QR code embedded into a physical carrier object (S100). The logging process is triggered synchronously with the scanning operation and continues through subsequent automated operations such as extraction of credentials or configuration profiles (S104), automatic device configuration for secure network access (S106), authentication with the mesh network (S108), and establishment of end-to-end encryption (S110). The audit log entry created for each scan event contains one or more of the following data fields: a globally unique event identifier; device identifier and device type; scanner application identifier and version; user identifier or session identifier when user authentication is present; timestamp with sub-second precision and clock-source identifier (e.g., NTP server or secure hardware clock); location information when available and permitted (e.g., GPS coordinates or network-derived location); raw or canonicalized QR payload and a cryptographic hash of the payload; decoded payload fields such as access credential identifier, configuration profile identifier, secure URL, nonce, or certificate fingerprint; result of payload validation and parsing; actions taken by the device in response to the payload (for example, network SSID selected, configuration parameters applied, keys provisioned); outcome of automated authentication to the mesh network including success/failure codes and the identity of the authenticating network node; identifiers for any network sessions or encryption contexts established (for example, session ID, key fingerprint, cipher suite); error codes and diagnostic messages in case of failures; retry count and backoff parameters; and a cryptographic signature or message authentication code (MAC) computed by the device to protect the integrity of the log entry.

To ensure integrity and non-repudiation, log entries are written to an append-only store on the device and are cryptographically protected. Cryptographic protection is implemented by computing an HMAC over the log entry using a device-resident key, by digitally signing entries with a device private key stored in a secure element or TPM, or by linking entries together using a hash-chain in which each new entry includes a hash of the previous entry. In certain embodiments, device-generated Merkle trees are constructed periodically and the Merkle root is published or anchored to an external timestamping or blockchain service to provide additional tamper-evidence and to enable independent verification of the order and contents of logged events. Time-stamping is also performed by a trusted time-stamping authority to provide an auditable global time reference.

Log entries are stored encrypted at rest on the device using keys bound to device identity and protected by hardware-backed key storage where available. When network connectivity permits, log entries are securely transmitted to a centralized audit server or to one or more distributed logging collectors for aggregation and extended retention. Transmission uses mutually authenticated TLS or an equivalent secure transport; entries can be encapsulated in a signed envelope to preserve authenticity during transit. A batching and retry mechanism can be employed to conserve device resources and to handle intermittent connectivity: entries are queued in an on-device buffer and uploaded when network conditions satisfy policy (for example, when connected to a managed backhaul or when battery state is above a threshold). Uploads include sequence numbers and monotonic counters to detect missing or out-of-order delivery. An acknowledgment protocol ensures that entries are marked as persisted only after the server confirms successful receipt and integrity verification; unacknowledged entries remain in the device queue and are reattempted according to policy.

The centralized or distributed audit repository indexes and exposes queryable fields to enable efficient compliance reporting and forensic queries. Indexed fields typically include event identifier, device identifier, timestamp ranges, QR payload identifiers, authentication outcome, and location. Role-based access control restricts who can view, export, or modify audit records; all administrative accesses to the audit repository are recorded in an administrative audit trail. For regulatory compliance, the system provides configurable retention policies to retain logs for periods required by applicable laws or organizational policies, and supports legal-hold procedures that prevent deletion of specified records. When privacy regulations or policy require, sensitive fields (for example, user identifiers or precise location) are pseudonymized or redacted in stored logs; raw data necessary for investigations is retained in encrypted form and is accessible only under escrow or multi-party authorization.

Audit entries include metadata useful for automated compliance monitoring and anomaly detection. Examples include rate metrics, geographic distribution of scan events, repeated failed authentication patterns, and scans of the same QR code from multiple disparate locations within implausible time windows, which are forwarded to a security information and event management (SIEM) system. The logging subsystem emits real-time alerts when predefined thresholds or rules are violated, enabling rapid response to credential leakage, cloning, or tampering. Integration points for external analytics and reporting tools are provided via application programming interfaces (APIs), common log formats (e.g., JSON, syslog), and export options (CSV, PDF) for audit reports.

Privacy and consent controls are integrated into the logging lifecycle. Prior to recording personally identifiable information, the scanner application or device prompts for required consent or operates in a privacy-preserving mode that records only the technical data necessary to demonstrate compliance. When anonymization is employed, reversible pseudonymization techniques or key escrow mechanisms enable authorized re-identification during legal investigations while preserving privacy during routine operations.

Failure modes and dispute resolution mechanisms are supported. In the event of suspected tampering, devices can retain a secure, immutable copy of recent audit entries in hardware-protected storage and provide a verifiable chain-of-custody exported to the centralized audit server. Audit entries include diagnostic and environmental context (for example, firmware version, sensor readings, hardware attestation evidence) that aid in determining the root cause of anomalies. Where divergent copies of logs exist, cross-verification using cryptographic signatures, Merkle proofs, or anchored timestamps enables reconciliation.

The logging architecture is extensible. Additional events beyond QR scans can be logged using the same schema and protections, including manual credential provisioning, remote configuration changes, firmware updates, and certificate lifecycle events. Configurable policies determine which events are recorded and the level of detail retained, balancing auditability against storage, bandwidth, and privacy constraints. The system supports software updates to the logging components that preserve existing cryptographic keys and maintain continuity of auditability across device lifecycles.

Embodiments described herein concern methods, systems, and apparatus for provisioning and authenticating camera-equipped devices for secure access to a mesh network by embedding a QR code into a physical carrier object and having a user scan that QR code to initiate automated, secure configuration and authentication. In one embodiment, a physical carrier object is provided with a QR code that is overtly displayed on an accessible surface of the object to facilitate user awareness and deliberate interaction. The physical carrier object can take the form of a tag, label, card, wristband, sticker, instruction sheet, packaging insert, device enclosure faceplate, key fob, or other tamper-evident or non-tamper-evident medium. The QR code is formed using visible ink with strong contrast, embossing, laser etching, a printed adhesive label, or other marking techniques suitable for reliable optical scanning by a camera-equipped device (S100). The overt display of the QR code can include visual affordances such as a border, iconography, text instructing the user to “Scan to connect,” color highlighting, or a recessed area. The overt display is configured to promote user awareness, consent, and intentional interaction, and can be contrasted with covert or hidden markings to mitigate inadvertent scanning and to assist in security and privacy practices.

If the QR payload contains only a secure URL rather than full credentials, the device initiates a subsequent network interaction by resolving the URL to a provisioning endpoint over an available network or by using an out-of-band channel. The QR code's secure URL can point to a bootstrap server accessible via HTTPS. The device can use the bootstrap server to exchange the extracted token or credential for network-specific credentials or a configuration profile. In alternative embodiments, the QR code contains self-contained credentials that enable immediate configuration without contacting an external server.

Upon extraction of the QR payload, the device automatically uses the information to configure one or more network interfaces for secure network access (S106). Automatic configuration includes programmatically populating network parameters into the device's networking stack, installing or importing certificates into a protected credential store, creating or configuring a supplicant profile, writing a PSK into a protected keystore, establishing VPN profiles, or applying mesh-specific routing and peer-discovery parameters. For example, if the QR payload indicates an 802.11 network and provides WPA2-Enterprise parameters and an EAP configuration, the device can create an SSID profile with the correct EAP method, install a client certificate and private key protected by the device's hardware-backed keystore, and enable automatic connection to the target SSID. If the QR payload indicates a BLE or Thread mesh, the device sets mesh network identifiers, network keys, application keys, and operational data required by the mesh stack.

Where additional verification is required, the device validates the authenticity and integrity of the QR payload (S104, S106). Validation techniques include verifying a digital signature using a known issuing public key or certificate chain, checking a certificate fingerprint against an expected value, validating an HMAC with a shared secret, and verifying token expiry timestamps. In some embodiments, the device validates the presence and correctness of a secure element identifier or platform attestation (for example, by verifying a TPM-based attestation) prior to using the credential. The device refuses or flags provisioning if signature verification fails, the token is expired, the device identifier is not authorized, or policy constraints are violated.

The overt display of a QR code on a physical carrier object provides user-visible evidence that the object is intended to be scanned for network access. Overt display is paired with human-readable instructions on the object that indicate the scope of access, the identity of the issuing authority, expiration conditions, and privacy notices. For example, an overt label can state: “Scan to join CompanyMesh—Valid for new devices only—Expires: YYYY-MM-DD.” This explicit presentation reduces the risk of covert or surreptitious provisioning, supports user consent workflows, and enables users to make informed decisions before enabling network access. In addition, overt display facilitates auditing and physical inspection; administrators can visually verify that devices possess the correct provisioning artifacts.

Protocols and data formats used during bootstrapping can include HTTPS with mutual TLS, RESTful APIs returning JSON, CoAP over DTLS for constrained devices, or vendor-specific provisioning protocols. Devices with limited network access can use the QR payload to establish an initial authenticated channel via a power-constrained radio or Bluetooth to a provisioning gateway that relays requests to the bootstrap server on the device's behalf. In such cases the QR payload includes parameters to identify the provisioning gateway or relay service.

The system supports lifecycle management operations including revocation, renewal, and re-provisioning. Revocation can be enacted by invalidating tokens on the bootstrap server, updating certificate revocation lists, or pushing configuration changes to mesh nodes to block specific device identifiers or keys. The QR payload can include an expiration timestamp or a one-time-use token to limit the window during which provisioning is permitted. For deployments intended for extended operation, re-provisioning procedures include rescanning a new QR code, contacting the bootstrap server using an existing device identity to request renewal keys, or using an administrative console to remotely rotate application keys and update device profiles.

Privacy-preserving features can be incorporated. For example, the QR payload can be designed to avoid embedding persistent device identifiers; instead, ephemeral tokens are used to minimize tracking risks. When user identity is not required, the payload omits personal data. Where user consent and identification are required, the provisioning flow can integrate with identity providers (IdPs) and leverage OAuth 2.0 or OpenID Connect flows initiated by the device after scanning the QR code.

The embodiments contemplate alternative and fallback workflows. If automatic configuration fails due to incomplete or corrupted QR payloads, the device can display guided manual configuration steps derived from the QR payload, present the human-readable portions of the payload to the user, or generate diagnostics and logs to assist administrators. The device can also limit automatic actions when user-configurable security policies require manual confirmation before applying network credentials.

Example operational sequences follow the reference steps. In a first illustrative sequence, the QR code is embedded on a printed card attached to a new sensor node (S100). A technician uses a smartphone to scan the printed QR code (S102). The smartphone decodes the QR and extracts a secure URL and an ephemeral provisioning token (S104). The smartphone automatically opens the secure URL in a provisioning client and posts the token to the bootstrap server, which validates the token and returns a device-specific certificate and mesh key material (S106). The smartphone installs the returned credentials into the sensor node's keystore via an out-of-band Bluetooth provisioning link or via USB, after which the sensor authenticates to a mesh gateway using mutual TLS with the installed certificate (S108). The sensor and a cloud service then establish end-to-end encrypted application-layer channels for telemetry data (S110). In a variant, the QR carries a self-contained signed configuration profile that, when decoded by the device's built-in camera, is authenticated locally against a trusted issuing public key and installed without contacting an external server.

The disclosed embodiments are compatible with existing mesh network architectures and standards, including but not limited to Thread, Bluetooth Mesh, Zigbee, and vendor-specific mesh solutions. Mapping between the QR payload and mesh provisioning primitives is performed by the provisioning engine in accordance with the target mesh stack specification. For example, when provisioning a Thread device, the payload can include dataset TLVs, network master keys, and operational dataset timestamps. The device applies those elements to its Thread stack and joins the network with the provided credentials.

Numerous variations and enhancements are possible without departing from the inventive concepts. Payload formats and signature schemes can be adapted to use different cryptographic primitives, including RSA, ECDSA, EdDSA, or post-quantum algorithms. The QR code can be augmented with machine-readable color patterns, multiple nested QR regions encoding different payload layers, or near-field NFC tags co-located with the overt QR marking to offer an alternate scanning modality. Policy-driven constraints can require that QR-initiated provisioning occurs only in secure physical zones or only by authenticated administrative users. Administrative tooling can generate and print QR-bearing carrier objects in batches, each QR uniquely tied to a particular device role or deployment site, and can track issuance logs for compliance and auditing.

Several security hardening measures are integrated to ensure rapid onboarding does not compromise overall system security. QR payloads include nonces and timestamps to protect against replay; provisioning tokens are single-use and expire rapidly after issuance. All payloads are signed by a provisioning authority and are encrypted for a designated recipient or class of recipients. Revocation mechanisms are provided: provisioning authorities publish revocation lists or issue certificate revocations with limited validity via the provisioning server; devices periodically check for revocation when connectivity is available, and policy requires that nodes fall back to conservative behavior (isolation or limited network participation) if revocation status cannot be confirmed within a policy-configured interval. Audit logs recording the time, location (where available and authorized), and operator identity associated with each provisioning event are generated for post-deployment accountability, with log entries cryptographically signed to prevent tampering.

Operational parameters and hardware considerations for emergency or covert deployment are described to enable robust performance. Optical recognition libraries used by the provisioning application tolerate smudges, partial occlusion, and reduced-resolution captures; error-correction levels and redundant encoding schemes are selected to maximize decode probability under adverse conditions. For constrained imaging devices or scenarios with limited user dexterity, the provisioning application supports voice, haptic, or LED feedback to confirm successful scans. For bulk rapid deployment, a distribution kit of pre-encoded carriers can be supplied with adherence instructions and deployment patterns to ensure sufficient network density and connectivity for mesh formation.

Lifecycle and maintenance of provisioned devices are addressed. Provisioned credentials include explicit lifetimes and renewal procedures: devices provisioned using embedded offline credentials are configured to connect to a provisioning server when connectivity is available to obtain updated credentials, rotate keys, or receive policy updates. For covertly deployed devices where direct retrieval is undesirable, a scheduled key rotation plan using pre-distributed seeds and deterministic key-derivation functions is employed so that devices autonomously refresh operational keys without contacting central infrastructure. Decommissioning and secure wipe procedures are defined; physical carriers are manufactured as single-use and tamper-evident, and provisioning authorities revoke tokens associated with lost or compromised carriers.

Example deployment scenarios illustrate practical application: first responders arriving at a disaster site quickly affix pre-encoded adhesive carriers to temporary relay nodes; responders use camera-equipped tablets to scan and instantly bring nodes into a secure mesh providing encrypted voice and telemetry. In another example, surveillance or specialized teams performing covert operations deploy micro-tag carriers on infrastructure; operators with authorized provisioning apps scan the hidden tags (visible only under ultraviolet illumination) to bootstrap field devices into a restricted mesh, with minimal radio chatter and cryptographically enforced access controls. In each case the steps of embedding (S100), scanning (S102), extracting payloads (S104), automatic configuration (S106), authenticating to the mesh (S108), and establishing end-to-end encryption (S110) are performed with optimized timing, reduced human interaction, and security measures balanced against the constraints of emergency or covert operations.

The device initiates an enrollment and authentication procedure with the mesh network S108. The mesh network recognizes and authenticates new nodes using the authenticated credential obtained from the scanned QR code. In one embodiment, the device presents the signed credential to a designated joiner endpoint or mesh controller node. The joiner endpoint verifies the credential signature and checks the credential metadata against a registry of authorized credentials. The registry can be maintained by a central provisioning server, distributed among controller nodes, or implemented as a blockchain or distributed ledger. The joiner endpoint is configured to issue a challenge (nonce) to the device; the device proves possession of the private key corresponding to a public key contained in the credential by signing the nonce or performing an authenticated key-exchange operation (for example using ECDH with signed public keys). Successful completion of the challenge-response exchange demonstrates both the validity of the credential and the device's control of associated key material.

In alternative embodiments, the QR-provided credential itself constitutes an ephemeral, single-use credential that encodes authorization to retrieve a longer-lived certificate. The device uses the QR-derived credential to securely fetch a device certificate from an enrollment server over mutual TLS (mTLS) or an authenticated HTTPS connection. The enrollment server verifies the QR credential, checks for revocation or prior use, and issues a device certificate signed by the network's certificate authority. The device then presents that certificate to the mesh controller as part of mutual authentication. In another embodiment, the QR credential directly contains symmetric key material encrypted to a device-bound key or to a hardware security module; possession and correct use of that symmetric key during an authenticated exchange is sufficient for node recognition and admission.

The mesh implements multiple safeguards to resist attacks and handle error conditions. QR-encoded credentials are typically time-limited and single-use to prevent replay; the network checks timestamps and one-time-use flags during admission. Revocation information, such as a certificate revocation list (CRL) or OCSP status, is consulted by the joiner endpoint before admitting a node. The network enforces rate-limiting and anomaly detection to prevent brute-force attempts to abuse enrollment endpoints. Tamper-resistant storage of private keys on the device (for example via a TPM, secure enclave, or hardware secure element) binds the credential to the physical device and mitigates credential exfiltration. When an onboarding attempt fails due to an expired token, malformed QR, or revoked credential, the device surfaces a user-visible error and presents a secure remediation flow that requires administrative approval or reissuance.

The techniques support a variety of mesh topologies and device classes, including constrained IoT nodes, user endpoints, and intermediate routing nodes. Access levels can be encoded within the QR credential so that the mesh assigns role-based permissions on admission (for example, client-only, router, or controller candidate). Multiple QR codes can be used for batch provisioning; a single QR can encode a link to a nonce batch that the device redeems to obtain device-specific credentials. The system also supports alternate out-of-band carriers such as NFC tags or Bluetooth advertisements that carry the same credential data structure.

In embodiments where the extracted credential includes an expiration timestamp, the device and the network perform expiration checks prior to or during authentication. When an access credential is found to be expired, instead of denying connectivity outright, the mesh network can implement a temporary-access policy to preserve continuity of service while maintaining security posture. Under this policy, upon detecting credential expiration either at the device during local validation (S104) or at the authentication server during S108, the network grants the device limited network access for a predetermined grace period. That limited access is provided by the authenticating node or by an authorization service that issues a limited-duration access token or ephemeral session credentials. The issued token is cryptographically bound to the device identity, for example by signing the token with the network's private key and including the device identifier and a validity interval.

Temporary network access following credential expiration can be constrained along multiple axes. Access scope can be limited to reachability only to the provisioning server or credential management endpoint, allowing the device to renew or replace the expired credential while preventing unrestricted access to other network resources. Alternatively, access can be configured for reduced throughput, denial of privileged services, restriction to control-plane communication, or exclusion from mesh routing to avoid propagation of untrusted state. The maximum duration of temporary access, a maximum number of temporary extensions, and whether reuse is allowed can be enforced by policy specified in the configuration profile, implemented in the authenticating node, or applied centrally by the credential management service.

Granting temporary access upon expiration can rely on multiple trust signals. For example, if the QR-encoded payload contains a recently-signed device certificate or a persistent device public key, the authenticating node can verify possession of the corresponding private key via a challenge. If the private key successfully signs the challenge, the node infers continuity of device identity and is authorized to apply the temporary-access policy. To mitigate replay and cloning attacks, the temporary-access token can be single-use, bound to a nonce, or tied to cryptographically protected device attributes (for example, hardware-backed key identifiers). Where the device is offline and cannot reach the provisioning endpoint, an access node can consult a cached revocation list or an allowlist of recently-expired credentials that were granted temporary allowance within a defined window.

During the temporary-access period, the network can automatically attempt credential renewal on behalf of the device. For example, the device can be granted network access only to the secure URL specified in the QR code or to a provisioning server; the device contacts the provisioning server over an authenticated channel to request an updated credential. The provisioning server, after validating the device's identity and any required policies (such as ownership verification or compliance checks), issues a renewed credential that replaces the expired credential in the device's secure storage and is then used to establish a full authorization state with normal network privileges.

The mesh network enforces audit logging and notification tied to temporary-access events. When temporary access is granted, the authenticating node records the device identity, the reason for temporary access (expiration versus revocation), the duration, and the allowable scope. Notifications are sent to administrators or to the device owner, and alerts are generated if temporary access is abused or if reauthentication repeatedly fails. Rate limits and anomaly detection are applied to detect attempts to repeatedly exploit temporary-access windows.

Other embodiments consider edge cases and security tradeoffs. If a credential is explicitly revoked (as opposed to expired), the network policy forbids temporary access despite possession of otherwise-valid signatures. In environments with significant clock skew, the network relies on monotonic counters, sequence numbers, or issuance timestamps validated against server-side time rather than device-local clocks. Where a device contains a hardware-backed persistent identity, the provisioning workflow leverages that identity to limit the temporary-access scope to the bare minimum operations needed for re-provisioning, such as contacting a certificate authority over TLS.

Cryptographic choices can vary by implementation. QR payload signatures can use ECDSA over NIST P-256, Ed25519, or RSA-2048/4096; symmetric session keys can use AES-GCM or ChaCha20-Poly1305; transport security to provisioning endpoints typically uses TLS 1.2/1.3 or DTLS; authenticated key exchange can use ECDH with authenticating signatures or certificates. Temporary tokens can be implemented as signed JWTs with a limited lifespan, as opaque tokens stored in an authorization server, or as ephemeral certificates issued by a limited-duration certificate authority subcomponent. The design contemplates fallback mechanisms where a human operator can manually validate identity and extend network privileges if automatic renewal is not possible, with such manual overrides logged and governed by policy.

These mechanisms enable secure, automated device onboarding via QR code scanning (S100-S106), robust authentication with the mesh (S108), establishment of encrypted channels and end-to-end protection between nodes (S110), and the pragmatic ability to maintain limited continuity of service by temporarily granting network access upon credential expiration while preserving opportunities for credential renewal and enforcing security policies.

A camera-equipped device scans the QR code S102 and extracts the encoded information S104. The extraction process validates the signature on the encoded credential using a preconfigured or discoverable public key for the network authority. If signature verification fails, the device refuses to proceed with automatic configuration. Following successful verification, the device parses the configuration profile and the access credential. The configuration profile includes one or more of: network identifiers, preferred mesh routing parameters, preferred interfaces and radio channels, time synchronization parameters, and URLs for supplemental configuration. The device populates its local configuration store with the provided profile items and imports the credential into a secure element or key store, setting appropriate usage constraints (for example, making the key non-exportable and restricting its use to specified protocols) S106.

Throughout onboarding and during subsequent operation, the system continuously or periodically generates audit logs that record events relevant to security and compliance. Audit records capture event type, timestamp, device identifier and credential identifier, authenticated network role, source and destination addresses, service endpoints accessed, volume and pattern of data flows, success or failure of protocol steps, configuration changes, and any policy violations. Audit logs are protected against tampering through cryptographic means: logs are signed by the logging entity, chained using hash chaining, and optionally anchored to an external timestamping authority. Logs are retained locally for a configurable retention interval and are periodically uploaded over an authenticated channel to one or more centralized or distributed audit collectors for analysis and archival storage.

Unauthorized activity is detected by automated analysis of audit logs and live telemetry following QR code onboarding. Detection mechanisms include rule-based engines that flag events such as authentication using an unexpected credential, repeated failed authentication attempts, device-originated traffic to prohibited destinations, indicators of data exfiltration, signatures of lateral movement, or sudden deviations from a device's established behavior profile. Machine learning models are applied to baselined behavior for anomaly detection, producing a confidence score for each potential incident. Detection criteria are expressed as policy rules that specify thresholds, time windows, correlation requirements across multiple logs, and required metadata to reduce false positives. The system supports human-in-the-loop review: flagged events are escalated to an administrator who can confirm or dismiss the alert prior to enforcement.

If audit logs and detection logic indicate unauthorized activity following QR code onboarding, the network revokes the device's access. Revocation is enacted automatically or after manual approval, depending on policy. Revocation mechanisms include adding the credential identifier or device identifier to a signed revocation list that is distributed to all authentication points in the mesh; publishing a signed revocation statement to a revocation service reachable via the secure URL encoded in the QR payload; instructing local access controllers to terminate active sessions and refuse future session establishment; withdrawing or rotating group keys so the revoked device cannot decrypt subsequent group traffic; and deprovisioning the credential from centralized identity services. To guard against replay attacks or latency in revocation propagation, the system employs multiple enforcement vectors such as immediate deauthentication messages to the device, updating route tables to isolate the device, and placing the device's port or radio interface into a quarantine VLAN or network slice.

Revocation enforcement is applied to preserve network availability while containing the suspected compromise. Policies can specify graduated responses: initially restricting a device to minimal-risk services or redirecting it to a remediation portal, and, upon confirmation of compromise, escalating to full isolation and credential revocation. The revocation process provides logging and audit-trail generation that records the identity of the policy or user that initiated revocation, the time of enforcement, and propagation status across mesh nodes. Forensic snapshots of the device and pertinent network nodes can be captured prior to or concurrent with enforcement, subject to applicable legal and privacy constraints.

Following revocation, the system supports remediation and re-onboarding processes. Remediation requires physical retrieval of the device to perform firmware updates, malware removal, or secure key replacement. Re-onboarding is accomplished by issuing a new QR code containing a fresh credential and configuration profile and by preventing reinstatement of any previously compromised keys or credentials. The system includes mechanisms to revoke or invalidate the original QR-encoded credential so that any subsequent scan of the original QR returns an error or a notification indicating the credential has been revoked and needs replacement. For audit and compliance, the full lifecycle—onboarding, detection of unauthorized activity, revocation, and remediation—is recorded and linked to the device's historical records.

To ensure integrity and timely enforcement of revocation decisions in a dynamic mesh environment, revocation statements are cryptographically signed and include sequence numbers or timestamps to resolve ordering, and are disseminated over authenticated channels. Mesh nodes verify revocation signatures prior to enforcement and honor the most recent revocation epoch. Where network partitions may impede immediate propagation, nodes cache and enforce revocation statements locally and reconcile state upon rejoining the mesh. To mitigate denial-of-service risks from erroneous or malicious revocation statements, the system implements safeguards such as threshold signatures that require concurrence of multiple authorities for revocations with significant consequences, administrative approval workflows for bulk revocations, and rate-limiting of revocation propagation.

Alternative embodiments incorporate different detection and revocation policies. For example, policies can focus on service-level restrictions, revoking only privileges assessed as presenting significant risk while leaving connectivity assessed as presenting minimal risk intact, or they can trigger adaptive rekeying of only the affected subgroup of nodes rather than global rekeying. Detection signals can be enriched by external threat intelligence feeds that correlate device activity with known malicious indicators. In another variant, the QR code lifecycle includes an embedded one-time-use indicator bound to the first successful authentication; if an audit indicates misuse, the one-time-use flag prevents reissuance and simplifies revocation checks.

Throughout, measures to preserve privacy and ensure compliance with applicable regulations are enabled by policy-driven controls governing the granularity and retention of audit data, selective anonymization where appropriate, and access restrictions on forensic artifacts. The described revocation mechanisms—based on audit-log analysis following QR-code onboarding—are compatible with a variety of network architectures and can be implemented as software modules in mesh-network controllers, as firmware in edge nodes, or as a combination of distributed and centralized services.

In one embodiment, a QR code is embedded into a physical carrier object (S100) that is specifically designed, manufactured, and distributed for use in disaster response or first responder environments. The physical carrier object includes laminated cards, adhesive tags, durable vinyl or polyester stickers, metal or anodized aluminum plates, plastic key fobs, fabric or silicone wristbands, velcro-attached patches, glow-in-the-dark or retroreflective placards, weatherproof pouches, or tamper-evident seals. The QR code is formed by printing, laser etching, stamping, embossing, or engraving, and the carrier includes features to increase survivability and legibility in harsh conditions such as waterproof lamination, UV-resistant inks, abrasion-resistant coatings, chemically resistant substrates, or raised/embossed patterns readable by touch. In some embodiments the QR code employs an enhanced error correction level (for example QR error correction level Q or H) and redundant encoding to tolerate partial damage, dirt, or occlusion common in disaster scenes.

Distribution of the physical carriers is adapted to first responder workflows. Carriers are pre-staged in first responder equipment caches, included in response kits and trauma bags, attached to incident command boards, placed on response vehicles and aircraft, affixed to casualty triage tags, and provided to incident commanders and sector leads at staging areas. In certain deployments, carriers are laminated into ID cards or wristbands that are distributed to personnel at mass-casualty events, shelters, or temporary medical facilities. Carriers are also physically affixed at scene markers (for example on tents, shelters, portable generators, command posts, or staging trailers) to enable arriving devices to join a local mesh network associated with that locus. Bulk distribution methods include sealed rolls, labeled envelopes, or waterproof pouches so that tokens remain usable after transport and deployment.

Includes setting a Wi-Fi SSID; selecting a predefined mesh radio channel and transmit power; installing an X.509 certificate or WPA3-Enterprise credentials; configuring virtual private network endpoints; applying firewall rules; and installing software keys for application-level end-to-end encryption. When certificate-based authentication is used, the QR provides either a client certificate and private key (stored or wrapped to prevent unauthorized extraction) or a certificate-signing URL and token that allow the device to obtain a signed certificate from a local or cloud-based certificate authority. If symmetric group keys are employed for rapid ad-hoc mesh formation, the QR supplies a group key or a seed from which group keys are derived; such group keys are scoped and time-limited to reduce the impact of compromise.

After successful authentication the system establishes end-to-end encryption between network nodes without manual credential entry (S110). End-to-end encryption can be established at multiple layers. At the link layer, WPA3-Enterprise or equivalent protocols secure the device-to-node link. At the transport or application layer, the provisioning process can automatically install application-layer keys (for example for secure messaging, telemetry, or command-and-control channels) so that traffic between peers is encrypted and authenticated end-to-end. Embodiments include automated key exchange protocols triggered by the initial provisioning such that peer devices derive session keys using device-specific key material provisioned from the QR or obtained from a provisioning service. Where necessary for scalability and compartmentalization, the provisioning service provides hierarchical or role-based keying so that only devices with appropriate authorization can decrypt specific data streams or access certain services.

Security considerations in embodiments include protecting sensitive payloads encoded in the QR from unauthorized reading and preventing replay or cloning. To prevent unauthorized use, QR payloads can require additional out-of-band validation such as device attestation, user biometric confirmation, or possession of a hardware-backed device private key (for example a secure element or Trusted Execution Environment). To mitigate cloning or replay at the scene, QR tokens can encode nonces and expiration timestamps, or be bound to physical carrier properties (for example embedding a signed unique identifier of the carrier and a tamper-evident seal). Some embodiments combine QR codes with other physical identifiers such as RFID/NFC tags; the QR provides human-readable or camera-readable convenience while the RFID provides a secondary verification channel accessible by dedicated readers.

The physical carrier design can incorporate features to facilitate scanning in reduced-visibility or chaotic conditions. Borders with strong contrast, printed alignment marks, reflective coatings for flashlight-assisted scanning, near-infrared ink readable by cameras but less visible to unaided observers, magnified symbols for cameras with limited resolution, and raised tactile markers for orientation can be included. Multiple identical QR copies can be placed on the same carrier at different orientations to simplify scanning when the carrier is attached in constrained locations. In hazardous environments where direct contact is undesirable, carriers can be affixed to long-reach poles or located behind protective transparent covers while remaining scannable.

Provisioning software on the device includes logic for policy enforcement, auditing, and minimal user interaction. The software records an audit trail of scans and provisioning events including time, location (where allowed), associated incident identifier, and provisioning outcome. Logs can be stored locally and optionally uploaded to an incident management server when connectivity is available to support post-incident review and credential revocation. The provisioning client enforces least-privilege principles; for example, a QR indicating a medic role yields medical-data access permissions but not command-and-control privileges. In some embodiments, QR-encoded role attributes are cross-checked against a central roster or directory service to prevent unauthorized privilege escalation.

To support operations when network access is limited, embodiments provide multiple operational modes. In an offline mode, the QR code encodes all required configuration and credential material so the device can become operational immediately without contacting external services. In an online mode, the QR code carries a secure token that the device redeems with a provisioning service to obtain per-device credentials, enabling tighter control and revocation. In hybrid modes, the QR code supplies a temporary group key for immediate local connectivity and simultaneously provides a URL to obtain per-device credentials once network connectivity is restored.

Manufacturing and issuance processes are adapted for rapid deployment and accountability. Carriers intended for first responder distribution are serialized, logged, and tracked using inventory systems. Packaging includes human-readable instructions, color-coding by role or privilege level, and tamper-evident seals. In training and preparedness exercises, carriers are pre-issued to personnel and integrated into drills so responders become accustomed to scanning workflows and trust models. Post-incident procedures include revocation, reissuance, and secure disposal of used carriers.

The described approach provides rapid, reduced-friction, and resilient provisioning tailored to disaster response and first responder scenarios. By combining physically durable carriers, secure encoding practices, automatic device configuration, and both offline and online provisioning modes, the system reduces manual configuration errors, accelerates secure network formation at incident scenes, and supports authenticated, encrypted communications appropriate for sensitive operational data and mission-essential coordination. Various modifications and combinations of the disclosed features can be implemented without departing from the scope of one implementation.

To prevent replay attacks, the access credentials encoded in the QR code are periodically refreshed and constrained by cryptographic safeguards. In one embodiment, the QR contains a time-limited bearer token that is valid only for a narrowly defined time window (for example, tens of seconds to a few minutes). The provisioning server issues tokens with embedded issuance and expiration timestamps and signs them using an asymmetric signing key (for example, ECDSA P-256) or an HMAC computed with a server secret. The device validates the signature to confirm that the token originated from a trusted issuer and verifies that the token is within its validity window. Because the token expires rapidly, capture and replay by an adversary at a later time will not succeed.

In another embodiment the QR code contains a rolling-code value or a sequence number together with a cryptographic MAC that binds the sequence to the issuing authority. The provisioning service maintains a sliding window of acceptable sequence values and consumes sequence numbers upon successful use, rendering previously used sequence values invalid. Use of sequence numbers can be combined with one-time-use tokens such that the server marks a token as used in a revocation list the moment it is presented for provisioning, preventing replay even within the nominal validity window.

A further variant embeds in the QR a seed for a time-based derivation algorithm (similar to TOTP). The device and the provisioning server both share the seed; the server accepts only codes derived from the seed using the current time-step value, so the credential displayed in the QR when scanned corresponds to a specific time period and cannot be reused later. When the physical carrier is an electronic display, the display can update to present a new QR containing the fresh code at each time step, thereby providing a continuously changing credential. When the physical carrier is a printed medium, the printed QR can encode an ephemeral token generated at the time of printing and intended for immediate use, or it can encode a seed plus a one-time nonce that the provisioning server will accept only once.

Cryptographic signatures and nonces can be used together to detect replay. For example, the QR payload can include a server-signed component containing a nonce and expiry; the provisioning server records nonces it has signed and rejects repeated presentation of identical nonce-bearing tokens. Alternatively, the provisioning server can issue a challenge at initial contact, requiring the scanning device to prove possession of a private key (for example, by signing the challenge) before receiving a longer-lived credential. This challenge-response mechanism ensures that possession of a captured QR payload alone is insufficient for authentication.

The periodic refresh process can be implemented in the system by regularly regenerating tokens at a credential authority and updating physical carriers via appropriate channels. For carriers that are reissuable or electronically addressable (for example, network-connected signage or reprogrammable e-ink badges), the credential authority can push updated QR payloads to the carriers on a scheduled basis. For disposable printed carriers, the issuance process can limit token validity to minutes or hours and require reissuance at the next contact. For security-sensitive deployments, the system can require combining the ephemeral QR token with device-bound attestation (for example, TPM-based attestation or mobile device attestation services) before granting persistent credentials.

Measures to mitigate clock drift and connectivity failures are included. When time-based tokens are used, the provisioning server accepts values within a limited window of adjacent time steps to account for clock skew, and the device is configured to synchronize time during the provisioning handshake using authenticated time services. If network connectivity is unavailable to validate a token in real time, the device can fall back to locally derived credentials generated from a securely stored seed, subject to policy restrictions, or defer provisioning until connectivity is restored. Audit logs of provisioning attempts, token issuance, and token consumption are maintained to detect anomalous replay attempts and to support forensic analysis.

The refresh interval, token length, cryptographic algorithms, and validity windows can be selected according to security and usability tradeoffs. Shorter validity windows reduce replay risk but increase reliance on timely scans and connectivity; longer windows improve usability but necessitate additional safeguards such as binding to device identifiers and enforcing one-time use. Typical choices for environments requiring stringent security include HMAC-SHA256 or ECDSA-P256 signatures, AEAD ciphers for transport and storage, tokens restricted to one-time use or to validity periods on the order of 30-300 seconds, and hardware-backed key storage on client devices.

Implementation variations include embedding a public key fingerprint or CA certificate in the QR code to allow the device to validate server-signed tokens without prior trust; encoding a URL that references an ephemeral provisioning session requiring TLS mutual authentication; or including provisioning policy metadata to instruct the device on which configuration profile to install and what post-provisioning reporting is required. The techniques described for periodic refresh and replay prevention apply across different wireless technologies and mesh protocols; the credential lifecycle and ephemeral token mechanisms can be used to bootstrap Wi-Fi, Bluetooth Mesh, Thread, or other mesh network authentication flows.

Using the extracted information, the device performs automated configuration for secure network access (S106). Automated configuration includes populating network interface parameters, installing a device identity certificate or key pair into a secure element or trusted execution environment, configuring firewall and routing policies, and preparing media subsystem parameters (codec preferences, maximum bitrate, hardware acceleration hints) suitable for real-time video. If the QR code provides only a bootstrap token and discovery URL instead of a full credential, the device uses the secure URL to contact an authorization server or certificate authority over an authenticated channel to request an ephemeral credential or a signed device certificate. This exchange is protected using public-key cryptography such that the bootstrap token authorizes issuance of credentials solely to a device that presents correct proof-of-possession of a generated private key.

Following successful authentication and enrollment, the system establishes end-to-end encryption between network nodes without manual credential entry (S110). End-to-end encrypted media channels for real-time video are instantiated as part of the onboarding flow so that video captured by the device can be transmitted securely to authorized peer nodes in the mesh. In one embodiment, the media path uses Secure Real-time Transport Protocol (SRTP) with keys derived from a mutual ECDH exchange between endpoints, ensuring that intermediate relay nodes that forward packets cannot decrypt payloads. Alternatively, the system can employ WebRTC with DTLS-SRTP for browser-based or app-based endpoints, or use QUIC with TLS 1.3 for reduced-latency encrypted transport. Where direct peer-to-peer connectivity is possible, Interactive Connectivity Establishment (ICE) with STUN/TURN assists in NAT traversal; when relays are necessary, relays operate as blind forwarders and are prevented from accessing plaintext by end-to-end authenticated encryption.

Encrypted real-time video transmission initiated during onboarding is provisioned to meet stringent latency and integrity constraints. Media capture begins after the device has obtained required cryptographic keys or has performed a fast-path key derivation that yields session keys suitable for immediate use. The system supports common real-time codecs such as H.264/AVC, VP8, VP9, and AV1, and negotiates codec selection and adaptive bitrate parameters as part of the configuration profile. To maintain continuity under variable network conditions, embodiments employ jitter buffering, adaptive bitrate streaming (ABR), forward error correction (FEC), and selective retransmission strategies compatible with tight latency requirements. Frame-level or packet-level encryption is applied using authenticated encryption algorithms (for example AES-GCM or ChaCha20-Poly1305) with per-packet sequence numbers to protect against replay and reordering attacks.

Key management for the video channels is designed to preserve end-to-end confidentiality and to enable rapid rekeying. In one approach, the onboarding handshake produces a master secret from which distinct key streams are derived for media encryption, media integrity, and control-plane signaling using a key derivation function (KDF) such as HKDF. Session keys are assigned limited validity periods and are rotated periodically or upon topology changes; rekeying is coordinated via the control channel using encrypted rekey messages authenticated by the current session keys. The QR-based bootstrap additionally contains authority-signed authorization for group membership; for group video sessions, the system derives group encryption keys using contributory group-key protocols so that only authorized group members can decrypt streams.

Privacy and protection of stored credentials are addressed by storing any persistent keys or certificates in a hardware-protected secure element, TPM, or secure enclave on the device. When devices lack hardware protection, credentials are sealed to the software configuration and protected by tamper-detection mechanisms. Credential revocation and expiration are enforced by back-end services referenced by the QR's secure URL; upon revocation, nodes cease accepting authentication from revoked device identifiers, and active sessions are terminated by invalidating session keys and issuing rekey commands.

An exemplary sequence integrates the following steps: a field technician brings a new camera node bearing a QR tag (S100). The technician uses an authorized provisioning tablet to scan the QR (S102). The tablet decodes the bootstrap URL and token, verifies the signature on the token, and initiates a secure connection to the provisioning service (S104). The provisioning service issues a signed, limited-duration certificate and a media configuration profile, which the tablet transfers to the camera node over a secured link (S106). The camera and one or more mesh endpoints perform mutual authentication and an ECDH key exchange (S108). Immediately upon completion of the handshake, the camera begins transmitting live video; the media stream is encrypted end-to-end between the camera and a monitoring station using SRTP with keys derived from the ECDH exchange, so that relay nodes in the mesh only forward encrypted packets and cannot inspect video content (S110). The video stream adaptively adjusts bitrate and employs FEC to maintain smooth playback despite packet loss, while periodic rekeying ensures only brief exposure of cryptographic material.

Alternative embodiments provide mechanisms by which resource-constrained devices can offload computationally intensive cryptographic operations to a trusted gateway during onboarding while preserving end-to-end confidentiality via gateway-facilitated key escrow only when authorized, or support out-of-band verification steps (for example, scanning a second human-readable code or performing proximity-based NFC verification) prior to enabling the video channel. The described methods provide a secure, streamlined means of bringing devices into a mesh network and immediately enabling real-time encrypted video communications without requiring manual credential entry.

The configuration profile extracted from the QR code includes parameters that directly control radio and mesh-layer behavior of the device. In particular, the profile specifies one or more channel selections (for example, an explicit channel number or a prioritized list of channels), bandwidth settings (for example, 20 MHz, 40 MHz, 80 MHz, 160 MHz, or channel bonding preferences), and encryption parameters. Encryption parameters can include the type of cipher suite to use (for example, AES-GCM, AES-CCM, ChaCha20-Poly1305), key lengths, the key derivation function and its parameters (for example, HKDF with specified salt and info), and the authentication and key management protocol to be used (for example, PSK, EAP-TLS, EAP-PSK, WPA3-SAE, or certificate-based mutual TLS). The configuration profile also includes mesh-specific parameters such as mesh identifier (MeshID), operating frequency band preference (for example, 2.4 GHz, 5 GHz, or 6 GHz), regulatory domain or country code, transmit power limits, channel reuse and coexistence hints, neighbor discovery intervals, mesh routing protocol selection (for example, 802.11s parameters or vendor-specific routing metrics), mesh role preferences (for example, root, relay, leaf), and timing parameters for scanning, beacons, and keepalives.

For constrained QR payload capacity, the configuration profile can be split across multiple QR codes or be kept minimal in the QR while pointing to a secure URL that hosts the full profile. When a secure URL is used, best practices are followed: the URL uses HTTPS with certificate pinning or includes a signed manifest so that the remote profile can be validated independently of the TLS channel; the server requires presentation of the QR-encoded token or a device-generated attestation to deliver the full credential material.

The device provisioning agent exposes policies that govern whether and how configuration parameters override existing settings. For example, a policy can permit automatic channel-setting changes only if the device is not currently in service or if the change will not disrupt ongoing connections; alternatively, the agent can defer reconfiguration until the next reboot or a controlled maintenance window. The agent logs provisioning events and can send anonymized or authenticated telemetry to the provisioning server for inventory and audit purposes.

Alternative embodiments include using other two-dimensional barcodes in place of QR codes; embedding the payload in NFC tags read by the device rather than via optical scanning; delivering the same configuration profile through a Bluetooth LE advertisement or pairing beacon; or combining QR-based provisioning with device attestation mechanisms (for example, TPM-based attestation) to bind the credential to a specific hardware identity.

Implementation examples: a smartphone scanning the QR decodes a JSON-formatted profile which includes fields: mesh_id, channel_list [36,40,44], preferred_bandwidth: 80, encryption: {type: “WPA3-SAE”, cipher: “AES-GCM”, kdf: “HKDF-SHA256”}, credential: {type: “psk”, value: “base64encodedpsk”, valid_from: “2025-01-01T00:00:00Z”, valid_to: “2025-01-31T23:59:59Z”}, provisioning_server: “https://prov.example.com/deviceEnroll?token=abc123”. The device verifies a signature over the JSON using a pinned provisioning public key, applies the radio settings via the wireless driver, stores the PSK in secure storage, performs an authentication handshake with neighboring mesh nodes or a mesh controller, and establishes encrypted communications per the supplied encryption parameters without requiring the user to type credentials.

The foregoing description illustrates various embodiments of QR-based provisioning where the configuration profile extracted from the QR code specifies channel, bandwidth, and encryption parameters for the mesh network. Those skilled in the art will recognize that many modifications and variations are possible within the spirit of one implementation, including different cryptographic algorithms, key distribution mechanisms, radio technologies, and physical carrier constructions, without departing from the scope of the described techniques.

Onboarding proceeds by automatically applying the configuration profile and initiating an enrollment flow with the mesh network using the extracted information (S106). Automatic configuration includes installing network parameters, setting allowable interfaces, populating initial trust anchors, and configuring device-local access controls. The onboarding flow enforces multi-factor authentication that combines QR code possession with a second factor selected from biometric verification or PIN entry. After extraction of the QR payload, the client device prompts the user for the second factor as specified by the payload metadata or administrator policy. For PIN-based second factor verification, PIN entry is performed using a secure input channel on the client device, the PIN is compared with a stored verifier or used to unlock a locally stored private key, and retry limits and lockout policies are enforced. For biometric verification, the client device performs biometric acquisition (for example, fingerprint, facial recognition, iris scan, or voice) and compares the acquired biometric sample to a stored biometric template or uses it to unlock a secure enclave that stores cryptographic keys. Biometric processing is performed entirely on-device so that biometric templates never leave the client device, and liveness detection techniques are employed to mitigate spoofing.

The multi-factor procedure is performed so that proof of possession of the QR code is combined with successful local verification of the biometric or correct PIN entry before the client device presents the provisioning credential to the mesh network or provisioning service. In some embodiments, the QR payload includes instructions for a challenge-response protocol: after QR decoding, the mesh or provisioning server issues a nonce challenge to the client device via the secure URL; the client device signs or encrypts the challenge using a private key that is unlocked only upon successful biometric or PIN verification, and returns the response to the server. In other embodiments, the QR payload contains a one-time provisioning token that is sent together with a biometric-derived attestation token or PIN-derived proof to the enrollment server. The enrollment server verifies the provenance of the QR payload, confirms that the second-factor verification was successful (via attestation tokens or verification of signed challenges), and only then issues persistent credentials or certificates to the client device.

Various alternatives and safeguards are supported. The second factor is a biometric modality selected from a list or chosen by an administrator; biometric templates are stored in a secure element or enclave to prevent extraction. PINs are used when biometric capability is not available; to improve security, PINs are combined with device-borne secrets or hardware-backed key material. Where privacy concerns arise, the system employs template protection techniques such as hashing, salting, biometric cryptosystems, or cancelable biometrics so that raw biometric data is never transmitted or stored centrally. For elevated-assurance deployments, the provisioning token encoded in the QR is revocable via a revocation list maintained by the provisioning server; the provisioning server checks revocation status prior to issuing credentials.

Fallback mechanisms permit re-onboarding or recovery when the second factor fails (for example, permitted administrator override procedures, out-of-band verification, or re-issuance of a QR code), and the system logs all onboarding attempts with an audit trail for compliance. Rate limiting, anomaly detection, and lockout policies help prevent brute-force attacks against PINs or repeated attempts to use captured QR payloads. The described approach allows automated, user-friendly onboarding while enforcing multi-factor authentication by combining physical possession of a QR-coded carrier with biometric or PIN verification, thereby enabling secure entry into a mesh network and automatic establishment of end-to-end encrypted communications without manual credential entry.

The physical carrier object containing the QR code is fabricated and configured to provide prolonged legibility, mechanical robustness, chemical resistance, and protection from environmental factors that could degrade machine-readable data. In certain embodiments, the carrier object is formed from a substrate selected for its dimensional stability and resistance to ultraviolet (UV) radiation, moisture, temperature cycling, mechanical abrasion, and corrosive environments. Suitable substrate materials include, without limitation, stainless steel, aluminum with an anodized surface, ceramic, glass, polycarbonate, polyethylene terephthalate (PET), polyethylene naphthalate (PEN), polyimide, fluoropolymers (e.g., PTFE), and engineering thermoplastics such as PEEK. The substrate is selected based on the anticipated operational environment of the mesh network node or physical equipment to which the carrier object will be affixed—for example, stainless steel or ceramic for marine or highly abrasive environments, and UV-stabilized polycarbonate for outdoor consumer applications.

The QR code can be applied to or integrated into the carrier object using one or more durable marking techniques. In one class of embodiments the QR pattern is permanently laser-etched or micro-ablated into the substrate surface, producing pronounced contrast in relief or color change that resists abrasion and solvent exposure. In other embodiments the QR pattern is printed using durability-enhanced inks and curing processes, for example UV-curable pigmented inks, ceramic-fired inks for metal or glass substrates, thermal transfer ribbons with resin-based inks, or inkjet deposition of specialty pigmented formulations with overcoat. The printed marking can be subsequently protected by a transparent, hard protective coating such as a UV-curable polyurethane or epoxy, a fluoropolymer topcoat, or a thin glass or ceramic laminate applied by sputtering, chemical vapor deposition, or anodic sealing in the case of anodized aluminum panels. The protective coating is selected to maintain optical contrast and minimize reflectivity or specular glare to ensure reliable optical decoding by camera-equipped devices (S102).

To enhance resistance to moisture ingress and chemical attack, the carrier object and any covers or bonded joints can be designed to meet an ingress protection rating such as IP67 or IP68, or NEMA 4X, as appropriate. Seals and gaskets can be formed from elastomers compatible with anticipated chemicals (e.g., fluorosilicone, EPDM, FKM) and engineered to maintain sealing performance across a specified temperature range. The carrier can be mechanically fastened to the host device with tamper-resistant fasteners, captive screws, or adhesives that provide a secure mechanical interface while allowing field replacement where required.

The dimensions and optical properties of the QR pattern are selected to balance scannability and durability. Module size and overall code size are chosen to enable reliable decoding by typical camera-equipped devices across expected working distances and viewing angles. Contrast-enhancing treatments are applied to the substrate surrounding the QR to establish a stable quiet zone and mitigate the effects of soiling or surface contamination. Anti-reflective micro-texturing or matte coatings are employed to reduce specular reflections that hinder camera image acquisition. When reflective or metallic substrates would otherwise produce glare, the QR pattern is filled with non-reflective ink or produced by surface roughening to provide diffuse scattering.

Manufacturing processes for the carrier object include redundancy and quality control measures to ensure field reliability. Examples include printing multiple, spatially separated QR copies on the same carrier, enabling alternate scan locations when one area is damaged; embedding a machine-readable fallback such as an NFC tag or RFID in the carrier for close-range provisioning when optical readout is unreliable; and performing accelerated environmental testing (e.g., ASTM B117 salt spray, ISO 4892 xenon arc weathering, thermal cycling over a specified range such as −40° C. to +85° C.) to verify retention of scannability and coating adhesion. The carrier is subjected to abrasion tests (e.g., Taber abrasion) and solvent exposure tests to confirm marking persistence.

Integration of the durable carrier object with the provisioning workflow described herein supports automated device configuration (S106), authentication (S108), and establishment of encrypted communications (S110) without manual credential entry. For example, when a camera-equipped device scans the QR code (S102), reliable decoding is facilitated by the durable marking and protective measures, enabling extraction of an access credential, configuration profile, or secure URL (S104). The device uses the extracted data to configure network parameters and initiate an authentication sequence with the mesh network (S106, S108). Because the carrier is engineered to preserve data legibility under field conditions, provisioning can be performed weeks, months, or years after initial placement of the carrier object without degradation of the onboarding process. In some embodiments the QR code encodes a URL pointing to an authenticated provisioning service accessible over HTTPS; the durable physical carrier effectively becomes a persistent link between the physical node and the secure provisioning endpoint, where the endpoint validates cryptographic tokens and issues ephemeral credentials or configuration payloads used by the device to join the mesh network and negotiate end-to-end encryption keys (S110).

The carrier object can be adapted for large-scale manufacturing and field service. For example, in injection-molded embodiments the QR pattern can be formed as recessed or raised features and subsequently filled with contrast material or coated with a durable finish; in metal-stamping or machining contexts the pattern can be laser-marked and passivated to resist corrosion. Mounting features such as slots, holes, or adhesive-backed surfaces are provided to accommodate different installation scenarios. If disposability or recyclability is a concern, the carrier can be configured as a removable module engineered to detach without damaging the host product, allowing replacement or secure destruction of the carrier at end of life.

To further reduce environmental-induced read failures, the carrier object can incorporate contamination-management features. For example, raised splash guards, drainage channels, or hydrophobic coatings can prevent accumulation of water, dust, or oils on the QR surface. Anti-fouling coatings or chemically resistant finishes are suitable for marine, industrial, or food-processing environments. For applications involving human handling, antimicrobial coatings or textured surfaces that reduce fingerprint transfer can be employed, while ensuring the optical properties necessary for scanning are maintained.

Redundancy and multi-modal identification techniques enhance reliability in adverse conditions. The carrier is configured to present multiple QR codes with staggered error-correction parameters, a human-readable serial number adjacent to the QR for manual lookup, and a concealed NFC or RFID element for contact-based provisioning. When confidentiality is paramount, the carrier is configured to require a two-factor interaction: physical possession of the durable carrier combined with cryptographic verification by a provisioning server, thereby mitigating risks associated with unauthorized capture of the visual QR.

To prevent reuse of the same onboarding credential by an unauthorized party, the QR code is rendered unreadable or otherwise made non-functional following successful onboarding. Multiple alternative and combinable mechanisms for rendering the QR code non-functional are contemplated.

One class of mechanisms uses logical server-side invalidation. The QR code encodes a one-time-use token, cryptographic nonce, or time-limited URL that is valid only for a single provisioning transaction. When the camera-equipped device decodes the QR payload and contacts the provisioning server (directly via the contained URL or indirectly via a provisioning application), the server validates the token and, upon successful completion of the onboarding sequence and verification of any required device-bound proofs of possession or device identifiers, marks the token as consumed in a backend ledger. Any subsequent attempt to use the same QR payload is rejected because the token is flagged as used or expired. The token is realized as a signed container that binds token lifetime, usage count (e.g., one), and, optionally, an intended device identifier or device-generated public key. The server-side state change that renders the token invalid prevents credential reuse even if the printed or displayed QR code remains visually intact.

Physical or chemical alteration mechanisms that render the QR code unreadable are also supported. The QR code can be printed using inks or materials that change optical properties irreversibly upon exposure to a specific stimulus triggered during successful onboarding. Examples include inks that change color when exposed to a brief pulse of electromagnetic radiation at a particular wavelength, thermochromic inks that irreversibly alter appearance when heated above a threshold, microencapsulated dye layers that rupture to smear the code when mechanically agitated by a microactuator, or UV-sensitive coatings that degrade after an initial exposure event. The provisioning application on the camera-equipped device can cause the required stimulus either directly (for example, by activating the device LED or by emitting a focused beam when permitted and when the carrier is in proximity) or indirectly via a networked command to an actuator embedded within the physical carrier (for example, an electro-mechanical shutter, a thin-film heater, or an electrochromic display layer). Where direct activation by the device LED is insufficient or inappropriate, the captured QR code payload can include a near-field wireless endpoint (e.g., NFC or Bluetooth LE) that the provisioning application negotiates with to command a local erasure actuator. The erasure action is executed only after the provisioning server confirms successful onboarding, or upon presentation of a signed command from the provisioning application, thereby linking physical destruction with logical acceptance.

Electrochromic, electro-optic, or electronically addressable display substrates enable a controlled transition from readable to unreadable states. A carrier incorporating a thin-film electrochromic overlay or an e-ink layer initially presents a QR pattern. After completion of the provisioning sequence and receipt of an authenticated command, the overlay switches to an opaque or pattern-distorted condition, rendering the code unreadable by subsequent image capture. The power and control electronics for such substrates are integrated into the carrier as a tamper-evident module and can be activated only once via a cryptographically authenticated message. Additionally, conductive traces printed around or through the QR pattern, upon activation by a momentary electrical pulse delivered by a controller, are caused to break and become open-circuited, producing a permanent optical disruption to the QR pattern.

Overprinting or occlusion techniques provide another physical approach. The provisioning application can cause a controlled dispenser within the carrier to deposit an opaque or diffusive material over the QR area after successful onboarding. Alternatively, a secondary printed layer configured to slide into place and cover the code can be released. These mechanical or fluidic mechanisms are configured to actuate only after receipt of an authenticated release signal to prevent premature or unauthorized destruction.

Time-limited fading or degradable printing is useful where server-side invalidation alone is insufficient. In this variation, the QR ink formulation incorporates photo-degradable or moisture-degradable components that irreversibly reduce contrast after a specified environmental exposure or following a triggered event during onboarding. For example, a carrier can include a sealed chamber that opens when a mechanical latch is tripped during provisioning, thereby exposing the QR print to a reactive atmosphere that induces fading.

Hybrid approaches combine server-side invalidation with physical rendering to provide defense-in-depth. The provisioning server invalidates the provisioning token while simultaneously issuing a command to a carrier-resident actuator to physically alter the QR code. The provisioning server records both actions in an audit log: token consumption and actuator confirmation. The provisioning application displays confirmation to the user showing completion of both logical and physical invalidation steps.

To guard against accidental non-functionality (e.g., if the QR is rendered unreadable before a successful onboarding due to manufacturing defects or premature actuation), a recovery workflow is provided that requires secondary authentication and operator involvement. Recovery can involve on-site administrator approval, presentation of alternate credentials, or access to a secure support channel that requires multi-factor authentication and audit logging. The recovery workflow is intentionally more onerous than the normal onboarding path to discourage misuse and preserve security.

An example sequence is as follows. The QR code printed on a carrier is scanned by a mobile provisioning application (S100, S102). The application decodes a secure URL and one-time token (S104) and contacts the provisioning server over TLS. The server validates the token and responds with a challenge. The mobile device generates a key pair and signs the challenge, proving possession of the private key; the server verifies the signature and issues a device credential or network certificate, recording token consumption (S106, S108, S110). Once issuance is successful, the server transmits an authenticated erasure command to the carrier-resident actuator or instructs the mobile application to trigger a local physical change; the actuator performs the physical alteration and reports status back to the server. The server updates the ledger to indicate both credential issuance and physical rendering of the QR code unreadable. Subsequent attempts to reuse the printed QR code fail because the token is consumed and the physical pattern is altered.

These embodiments prevent credential reuse by combining single-use logical tokens, device-specific binding, server-side state transitions, and physical rendering techniques that together ensure that once an onboarding operation succeeds, the same QR code cannot be used again to provision another device or to re-provision the same device without undergoing an authorized recovery process.

The present embodiments describe private networks for secured communication between devices. In particular, the devices communicate with each other over a private network created for a closed or semi-closed circle of devices. Furthermore, the offline communications between devices may be handled and properly distributed within the exemplary network.

For various reasons, individuals may wish to organize into specific private circles in order to securely communicate between themselves over a private network. For example, these individuals may wish to communicate on a shared interest such as an event, a sports team, certain promotions or a scholarly topic. In some instances, members of a private circle may wish to collaborate by revising and commenting on one or more documents or other file format, such as a calendar, presentation, workbook, media file, etc. Exemplary embodiments may communication over a private network to provide additional security by avoiding the use of cloud-based resources. In addition, such private networks may be formed quickly and relatively inexpensively.

The system and methods of exemplary embodiments can also provide for managing offline activity of the member devices within a private circle. For instance, messages, comments, revisions, etc. that are made when the sender's device is offline may be distributed to other devices. Therefore, this feature may not restrict private circle member activity to only those that are online.

Exemplary contemplated devices for use in the private circle may include any computing device suitable for communicating with another device over the private networks described herein. For example, the devices may include mobile computing devices such as mobile phones, tablets, laptops, and the like. Moreover, the type of communication may include any type of data transmission between two devices over a secure tunnel connection. As further described below, such data can include SMS messages, MMS messages, document files, media files, text files, presentations, voice, videos, audio recordings, or any other suitable form of data that can be communicated over a secure tunnel. In exemplary embodiments a “secure tunnel” refers to a secure or encrypted communication over or through an unsecured space or across an unsecured boundary. A non-limiting example of such encrypted communication is via Secure Sockets Layer (SSL) protocol.

In an exemplary embodiment, a method of providing secured communication over a private network of devices includes providing a microserver framework and a private circle application to members and a publisher. In one embodiment, a publisher creates a private circle using a miroserver framework and a private circle application and invites members to join this circle. Upon joining, the members and the publisher form a private closed circle.

As used here, “publisher” generally denotes an individual device that arranges a specific private circle and invites at least one other person to join that private circle. Thus, the publisher may be regarded as the administrator of the individually formed private circle. The individuals who join the private circle are referred to as “members.” Therefore, the publisher who is also part of the private circle can be regarded as a member as well. In some embodiments, the publisher and/or member(s) are an individual representing a business entity.

In an exemplary embodiment, a publisher determines the private circle features. The private circle features may include member data and private circle data. The member data can include name, contact information (address, email, phone number, etc.), position, title, or any other relevant information about a member. The private circle information can include essentially any information of interest to the members. For example, a calendar of events, restaurant menu, list of promotions, professional-client data (e.g. medical, legal or other sensitive data) or emergency/disaster information, all of which may be constantly updated or commented on by the publisher and/or members. The private circle information may include data and/or files containing data; files may include calendar files, document files, media files, etc. The publisher creates and publishes a private circle application (scheduling, storing, exchanging, messaging, etc.) to run on a microserver framework. Once installed on a device, one microserver can serve multiple private circle applications.

In an exemplary embodiment, a private circle application allows members within a particular circle to communicate with each other. To that end, the publisher furnishes the private circle features to a private circle application template. The private circle application, using this template, is then unique with respect to the members and the private circle data.

For example, a publisher can access a website for downloading the private circle application and a template with the desired look and functionality. The template and the private circle application are then provided to the publisher's computing device, such as desktop, laptop, smart phone, tablet, etc. (referred to as the published host device). The publisher may then populate, modify, or make selections for the template with the private circle features of interest to the specific application of the intended private circle. For example, the publisher may add member name and contact information (either as data fields and/or as actual data entries) as well as a calendar with meeting times. The template and private circle application are then downloaded to the publisher device. A secured method of transferring this private information involves a hard wire sync cable between the publisher host device and the publisher device. The populated template and the private circle application may also be provided directly from the website to the publisher's device without the intermediate step of downloading to the publisher's host device, and synching with the publisher device.

For added security, the publisher may delete the private circle application and the template from the PC after it has been transferred to the publisher's device. Therefore, the potentially sensitive private circle data is only accessible on the publisher's device. Moreover, such data is only sharable via the secure tunnel with only the selected members of the private circle. Accordingly, an exemplary embodiment permits the creation of a private circle without providing any personal, sensitive, or specific data to a remote server before or during creation and/or subsequent use of the circle.

In the present embodiments, a microserver framework provides a framework for one or more private circles. The publisher creates and publishes a private circle using a private circle application running on a microserver framework. Only members within a particular circle will have permissions to that private network. The mircoserver framework can use a Security Manager to handle the private network's secure communication channels (VPN, https, etc.), firewall, authentication, authorization, and crypto (communications and data). Accordingly, a private network is created when each device within a private circle installs a microserver framework which distributes data throughout that network to each authorized device in the individual and separate circle.

In order to connect the members within a private circle, the publisher can send an invitation to each member device. After downloading the microserver framework and the private circle application, the publisher invites other members to join the specific private circle. The invitation may be, for example, a text message with information regarding the private circle. Further, the text message may include links to a location for downloading the microserver framework and private circle application.

A separate invitation may be sent from the publisher device to a first member device and a second member device. An invitation may also first be sent from the publisher device to a first member device, and the first member may then re-send the same invitation to a second member. As such, members may be able to invite other members within the private circle.

The system may be used with any number of members devices as supported by the network(s) of the devices. Therefore, the number of members in any given circle is limited only by the ability of the network(s) to sustain them. If the network, device storage, and processing power is robust, there is the ability to support millions of circle members.

The invitation also includes information for installing a microserver framework. The members and the publisher may install the microserver framework on their separate devices to establish a private network connection, such as a secure tunnel, between their respective devices. The private circle application may then allow the private circle data to be communicated between the members securely over this secured network.

Upon confirming the invitation receipt, and downloading the applications, the confirmed member's device receives from the publisher device, the security information for establishing a secure tunnel with others in the private circle. The security information provided can comprise keys, handshake, authentication and any other security files required to establish a secure tunnel with the other devices.

In the present embodiments, the private circle application supports specific private circles that can be publisher-built or pre-built configuration files. User functionality (scheduling, storing, exchanging, messaging, etc.) is provided within the private circle framework. This framework may allow access to local device resources including import capability to integrate data into the private circles. Additionally, a public API can support third party applications allowing access to the microserver framework. The microserver's install manager can handle device bootstrapping, user enrollment/reenrollment, etc. while the instance manager tracks all private circles and any authorized third party applications. It can manage the entire instance life-cycle and current Private circle status. Additionally, the microserver's Data Store function can manage data for each instance, can handle replication and conflict resolution, as well as clean-up after de-provisioning. Configuration of functionality occurs through a permissions-based Administrator (publisher) user interface (UI). The microserver and private circle application functionality may depend on and utilize resources of the device operating system. As such, the number of private circles, (or private networks) available on any device is limited only by the capacity of the device.

In an exemplary embodiment, the Publisher (system administrator) can therefore create and publish one or more private circle applications (scheduling, storing, exchanging, messaging, etc.) to run on the microserver framework. The publisher initially sets a list of members to be notified and invited into the private network. Once the network is established members may be allowed to invite new members to join and change access privileges. Once installed on a device one microserver framework can serve multiple private circles simultaneously. The microserver instance manager can track all private circles and any authorized third party applications, including software, hardware, input/output, user interfaces, etc. It can also manage the entire instance life-cycle and current private circle status. The microserver's data store function can manage data for each instance, handle replication and conflict resolution, as well as clean-up after de-provisioning. Configuration of functionality can occur through a permissions-based Administrator user interface. The microserver and the private circle application functionality can depend on and utilize resources of the device operating systems. Thus, the number of private circles, thus private networks, available on any device is limited only by the capacity of the device.

Data flow may be managed differently based on the system design. For example, a secure tunnel between the members and the publisher may or may not include an intermediary device for relaying the messages between the devices. Therefore, the secure tunnel connects the members, the publisher and an intermediary relay device. The devices may also be directly connected or directly communicate without a relay.

In one embodiment, the member devices communicate via a client-server model. As such, the request from a device may be satisfied by an intermediary device within the private network. An example of an intermediary device is a central server for relaying data between member and publisher devices. In an embodiment, the member and publisher devices communicate as a peer-to-peer network. Thus, a request from one device is directly satisfied by another device. In yet another model, the devices communicate on a hybrid model, using both client-server protocol as well as peer-to-peer networking.

In a peer-to-peer scheme, the device communication can be distributed over one or more devices. For example, the publisher device may be the source for communication across the private circle. When data speeds or loads to the publisher device exceed a threshold amount, or when the publisher device is unavailable, one or more other member devices may be used to support the communication or data transfer across the private circle. Downloading data or transferring data onto one device can become easier as more members join the circle. That is, when the load is distributed over many devices, downloading speed for private circle data can improve. Accordingly, in one embodiment, the member and publisher devices further comprise a peer-to-peer file sharing application. Thus, devices may also include an application enabling a peer-to-peer file sharing protocol (e.g. BitTorrent) for file sharing between devices.

The private circle application provided to a member device can include instructions for communicating private circle information with another member device with the same application. The members and publisher may send direct or offline messages between their devices. As such, in one embodiment, the member and publisher devices include a messaging archive file for managing messages. This messaging archive file may be stored locally on the device and may be created by or downloaded with the private circle application.

In an exemplary embodiment, when a message is “sent” from a member or publisher device that is offline (not connected to the private network of devices), the message is written to the messaging archive file for later communication. When the device goes online (connects to the private network of devices), the message(s) written to the archive file are distributed with message archives of other members. If the sending and receiving devices are online, the message may be both written to the messaging archive file and also sent directly to the other devices. The archive file may therefore be distributed continuously or periodically between devices.

The type of messages contemplated includes essentially any type of data that can be transmitted between two devices over the secure tunnel. In one embodiment, the message is a direct message between members or between a member and the publisher. Specifically, the message can include private circle data, where, for example, a publisher or a member is adding an entry within the template for a specific private circle. The private circle application interface need not be browser-based. Thus, it can be customized to accommodate many different types of interfaces.

In one embodiment, a private circle includes members collaborating on at least one document or other file type. Here, the private circle application permits access to a document file over the secure tunnel. The document file may be any type of document such as, a Word, a PowerPoint, a PDF or any other document format of interest. The file types are also contemplated, such as, for example, calendars. Thus, the members or publisher may provide messages, comments or edits to a document or other file type. In some cases, members may have different levels of access, such as read-only, comment-only, or full edit control privileges. Member access level may be set by the publisher or determined by the members. This status may be assigned when the private circle application template is first distributed, or assigned after the member has joined the private circle. Moreover, the access level may be fixed or variable for the duration of the private circle collaboration.

In an exemplary embodiment, the document is on a server within the secure network, and the members and publisher connect to this server to access the document. Here, the server manages the comments and new versions of the document created by each member or publisher. In one instance, the server may be the publisher device or a member device.

In an exemplary embodiment, each member and publisher device has a duplicate copy of the document (or other file type) locally on the individual device. In this case, the comments and revisions seen on each device can be distributed to other members periodically or continuously to permit efficient collaboration.

In one example, a first member with appropriate level of access may provide a comment on the document version on the first member's device. This initial comment may then create a link on the document to which a messaging archive file may reference or which references a messaging archive file. Accordingly, a second member is able to view the comment(s) via a link on the document to a consolidated list of comments across members. Each member may contribute to a comment to create a message stream for that comment. Each subsequent message on the message stream may create a running message thread that is saved in one or more message archive files. As such each new comment (e.g. on a different section of the document) may result in a new comment stream and a new version of the document. The comment streams may be stored on different messaging archive files or within the same messaging archive file. Additionally, each device may comprise a new archive file for each new comment stream where these files are distributed to reflect the latest messages from each member or may comprise a single archive file for each document across all users or may comprise a single archive file per document per user so that a new archive file is generated for each member for each document.

The messaging archive file for comments on a document can be distributed across devices to ensure efficient collaboration. If a first member creates an initial comment or adds a message to an existing comment stream while the first member device is offline, a messaging archive file may be created (if first comment) or updated on this device to reflect the new entry. At this time, a second member, who is online, will not see the new entry from the first member. The second member can create a comment or add to a comment stream that may also create or update a messaging archive file. The second member's messaging archive file may then be distributed with the messaging archive file on other devices that are also online. When the first member device connects to the network, his messaging archive file may then be distributed with other devices online, and other members can see the comment. When a member then views a comment within a document, the distributed archive files are compiled into a single arranged and integrated list.

In one embodiment, each entry (comment or message) receives a timestamp such that members of a private circle are able to see when a comment or message was made, and/or the comment may be inserted into the appropriate chronological location of a comment stream when comments are distributed across on-line and off-line devices coming back on-line. Specifically, the messaging stream may be viewable in real time, similar to a chat window, for the devices that are online. Members may also be able to directly message each other and are not limited to only messaging on the document.

In an exemplary embodiment, a comment string may be created and anchored within a document or other file type. For example, a comment location may be identified either by a specific location in the document (page, line, pixel, coordinate location, etc.) or by a tag or other identifier to specific text, image, etc. The anchor may be saved directly in the document or in a user's revision file. If the anchor is part of the document, then the document may be saved as a new version and the version control for editing a document may be employed. The original comment may also not be saved within the document, but also be included within an individual member's archive file. Members may thereafter comment or continue the comment string. The original or additional comments may or may not alter the document itself. If the comments do not alter the document itself (e.g. when an anchor does not alter the document or when comments are continuing an already anchored comment string), they may not require implementation of the document revision control, such as checking out the document. For example, a member may make a comment in a comment string. The comment may include comment data such as a time, the document, and an anchor (either within the document or separate from the document) to indicate where a comment belongs, in which document, and the time it was made. The comment data may be written to the individual member's archive file. When a comment is viewed by any member, the private circle application may retrieve the individual member's archive files and integrate the various files for display to the viewing member. For example, the comment data may be retrieved from various member archive files, and the comments arranged and displayed in a desired order (such as chronologically or by member) and overlaid on the document, such as through an overlaid viewer, window, or other application outside of the document or working in conjunction with the document (such as using the comment feature already employed within a document software). In this way, multiple comments may be made simultaneously or sequentially without having to lock a document or handle revision controls on the underlying document or file type.

Similarly, when a user is off-line, they may also continue to comment in a similar fashion. Their comments may be saved in the individual member's archive file. Once on-line, the previously off-line member's archive folder may be read by the private circle application across other on-line member devices, and the previously off-line member's comments incorporated into the comment string(s) in their appropriate place (such as chronologically or by member or appended at the end as new to the circle comments).

As just described, each member may have their own archive file to which they have read/write access and can write or log their respective edits. The individual member files may be shared across devices periodically or in real time such that an individual member may have a separate archive file for each member of the private circle or for each member that has made a comment or modification to a base file. Each member may also have an archive file for their own comments and modifications and another combined archive file that includes the edits and comments of all of the other members integrated into a single “other” archive file. The individual member device may also only retain the member's archive file for the given device, and the private circle application retrieves and displays the data across the devices to integrate comments into a complete string without locally saving an archive file for the entire string or for other member contributions to the string. The individual member may select to back up the comments string, such as for review when going off-line, and retrieve the comment string of other members. The shared member files may be stored on each member device and/or a host device, such as the publisher's device. Other member's files may or may not be editable by the storing device, if the storing device is not the member device to which the member archive file corresponds.

The comment display may be set at the private circle application level, such that all members have the same user interface experience, or may be set at the individual member level. For example, each member may decide to view the comment strings in their own way. One member may choose to view comments chronologically, either based on the comment creation time or comment shared/distributed time (for those that share comments after being offline); while another member may select to view comment segregated by member. The entire user interface of the application, and not simply the comments may be set at the individual member level or across the entire application.

Document editing and revision control may be handled in different ways.

In an exemplary embodiment, each member and publisher device includes a storage medium comprising a document revisions folder. Each time a document is edited (add/remove text, change formatting, etc.) on a first member's device, a new version of this document is created in the revisions folder of this device. When the first member device is online, the second member device will then update its revisions folder to obtain the latest version of the document. As such, the document revisions folder for each device can contain multiple versions of a document edited by different members. This can be advantageous for a private circle having relatively few members or a private circle where only a few members have editing privileges.

In an exemplary embodiment, revision control is handled using a check-in and check-out system. Accordingly, when a first member checks-out the document, the document is then locked on a second member device (and other devices) for editing until the first member checks the document back in. The check out may occur as soon as the document is opened with the identified intent to edit the document. The member may therefore open a document as read only or as read/write. The check out may also occur as soon as the document is edited by the first member viewing the document, thereby locking the document from being opened with write privileges or permitting edits on an already opened document on another device. The other members may have permission to provide comments or contribute to a comment stream while a document is checked out. This system of access can be accomplished in various ways. For example, members may need to go through the private circle application in order to obtain permission to edit their document. Therefore, the private circle application may permit only one instance for editing. Accordingly, after the first member selects editing permission on the private circle application interface, the second or any subsequent member will not have the option to obtain the same privilege until the first member cancels his permission. Members may also message each other to coordinate turns for editing the document. Documents may also include an editable flag or other indicator that identifies whether a document may be edited. Once an edit is made to the document, a notice may be sent across the circle to limit edit privileges on other devices by changing the flag associated with the document.

Distributing data across devices may be based on different factors. For instance, constantly distributing a new revision of a large document file across devices may require significant resources. On the other hand, infrequent messages may not require as much resource. In an exemplary embodiment, data is distributed to all the online devices on a predetermined schedule. For instance, on-line devices may receive data every few hours, minutes or seconds. In another embodiment, all devices may receive data at a predetermined time (or times of the day).

If a document is edited, either off line, or after a document is checked out, the document versions may branch such that a document revision tree is made. For example, if a member is offline or must edit a document after the document is indicated as checked out (or if the check out feature is not used to restrict edit capabilities), then the first “checked-out” or document with the first revision may be designated as the primary document, and a back-up or separate branch is made of a document originating from a version before edits of the first revision are made, thereby having different revisions from the original. Separate versions of the document may therefore exist thereafter. Alternatively or in addition thereto, once the different document revisions are checked in, the revisions may be integrated back into a single version. For example, the documents may be incorporated sequentially with edit identifiers (text removed or added) sequentially from the original document, to the first revision, to the second revision. The edits may also be recognized as originating to the same or different portions of the original document text. If the changes are to different portions of the text, then the modifications may be incorporated to the respective portions without conflict. When edits are made to the same portion, then the alternate portions may be indicated sequentially or in the alternatives such as by changing the actual text edits to comments where the comment is the proposed or modified text, and each alternative is its own comment. Both options for the language may be inserted into the body of the document. The modifications may be identified, such as by strike through, underlining, bolding, highlighting, color coding the text, or otherwise to indicate and addition, deletion, or source (member) of the edit. One or more edits may also be simply made as comments appended or tagged to a line, letter, or word of text. In this case, the modifications may simply be proposals. The text may be incorporated into the document (i.e. the modification identifiers and/or comment text) once one or more members have approved the modification. For example, the publisher may have modification approval rights, or a modification may be approved with a majority, or identified set or sub-set of members. Once approved, then the proposed text or otherwise identified text becomes the new text or section of the document and the identifiers may be removed.

A publisher may create multiple private circles. Thus a publisher may be a member of different private circles which would communicate over different secure tunnels. Similarly, a member may join many different private circles. Thus, each private circle would have its own template and secure tunnel path.

After use, a private circle may be decommissioned. In other words, the private circle is dissolved and the members will no longer be able to communicate over that private network. In some instances, the private circle data may be retained for setting up a similar private circle in the future.

In one embodiment, the use of the private circle application and related services may be subscription-based. For instance, a recurring monthly fee may be applied to the publisher account while the private circle application is in use. This subscription fee model may vary based on the features used, number of members, level of support required, and type of template needed, among other things.

### DETAILED DESCRIPTION OF THE FIGURES

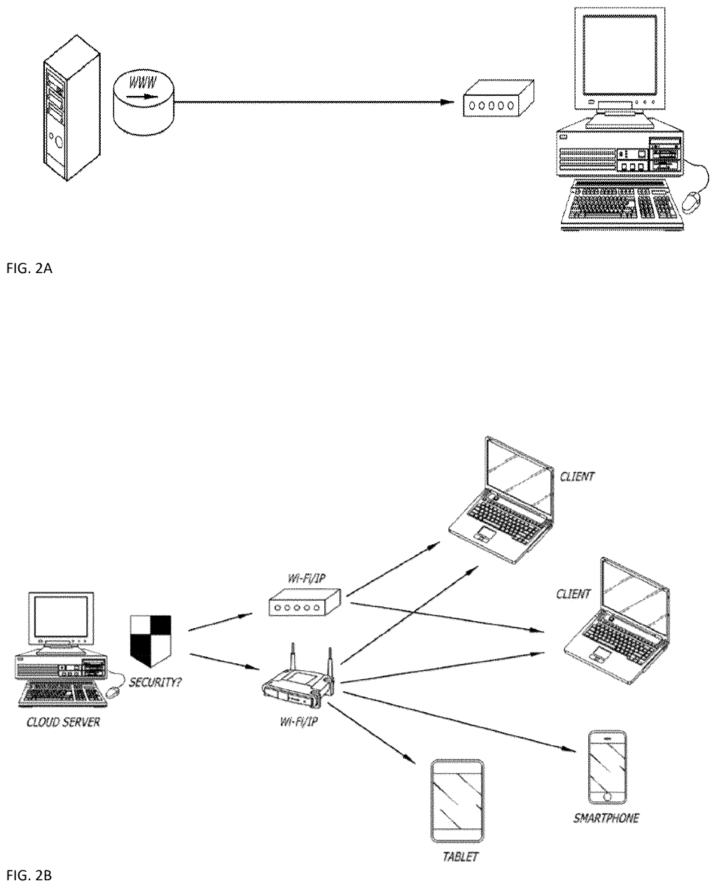

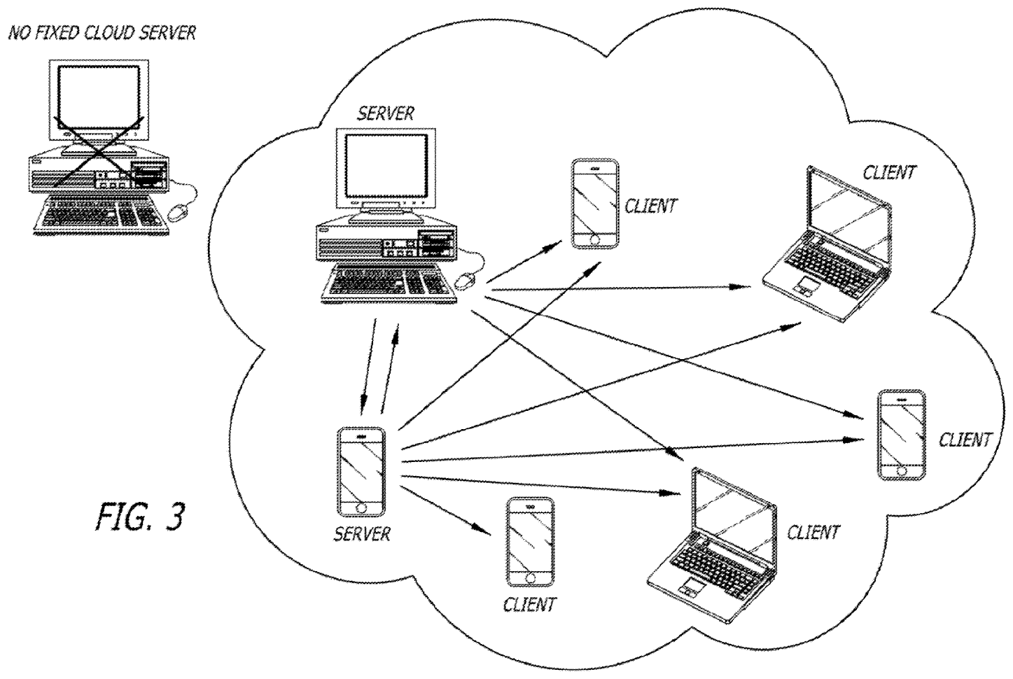

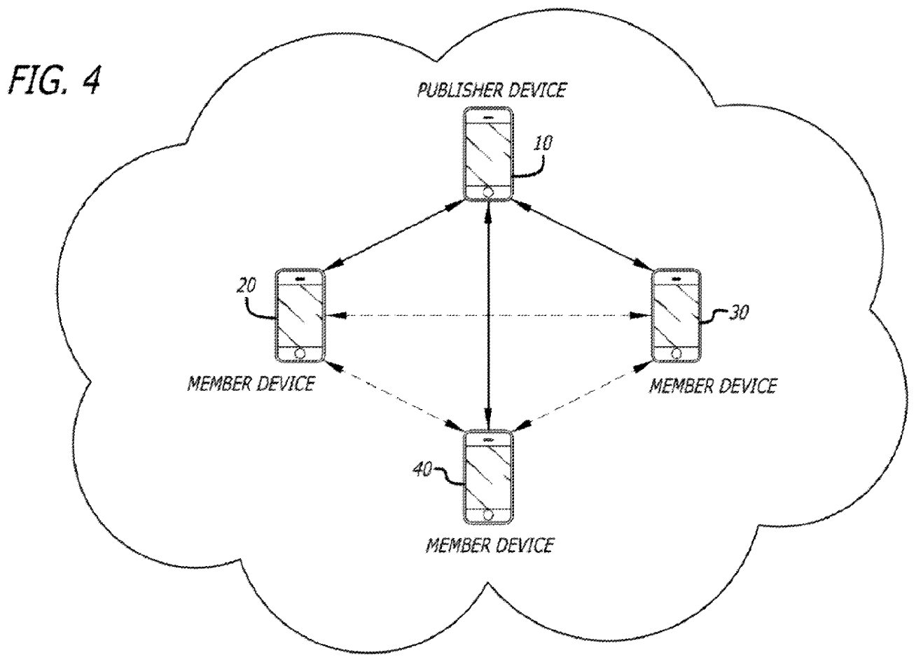

Networks have evolved from a simple client and server arrangement shown in FIG. 1 to multiple devices connected to a cloud server as shown in FIG. 2. With this increased complexity, additional security concerns arise. Exemplary embodiments described herein include a private cloud of devices as illustrated in FIG. 3. Exemplary embodiments may improve security in networked communications by avoiding a fixed cloud server location that may be monitored or hacked by an outside observer or perpetrator. As shown, the tablet and mobile phone devices form a cloud where the devices operate as clients and servers.

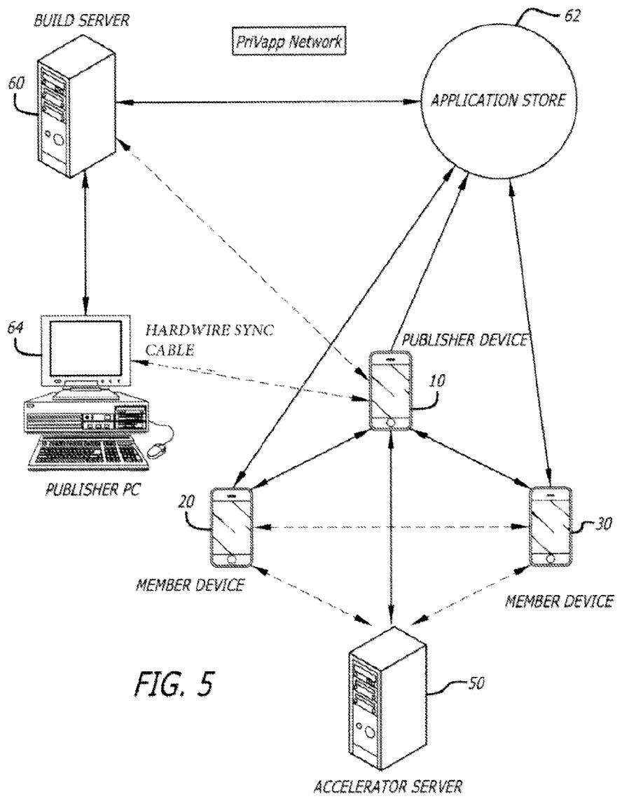

In the embodiment shown in FIG. 4, the member devices 20, 30 and 40 along with the publisher device 10 form a private cloud. This arrangement may further include an accelerator server (not shown) to facilitate communication, particularly if the number of members increases.

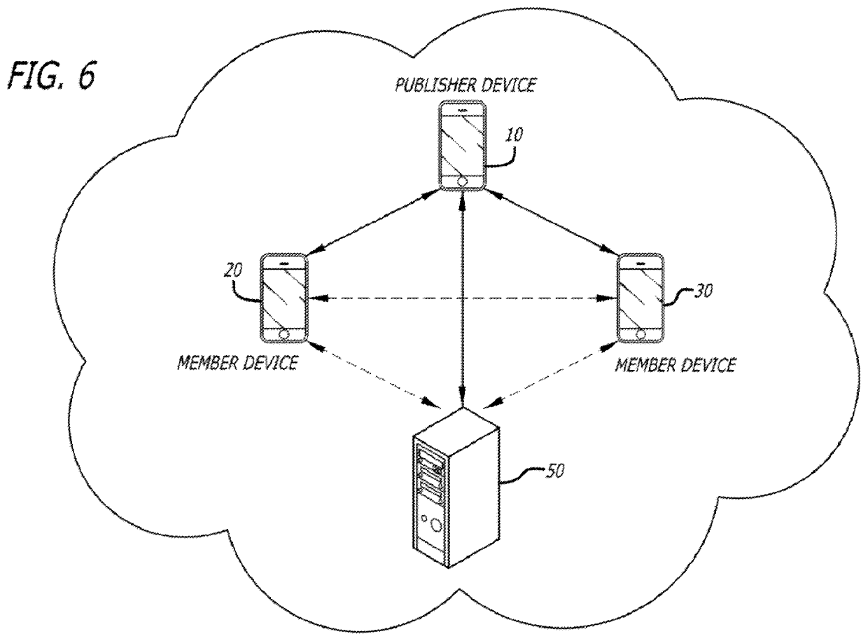

In one embodiment, building a private network involves providing microserver (e.g. SoftServ) framework and private circle (e.g. Privapp) application to members and publisher. As shown in FIG. 5, the framework and application from the build server 60 can be provided to the publisher 10 and members 20 and 30, via the application store 62. The publisher 10 can customize the private circle application and download to the publisher's PC 64, before synching with the publisher device 10. Here, the network to be formed between the devices further comprises an accelerator sever 50.

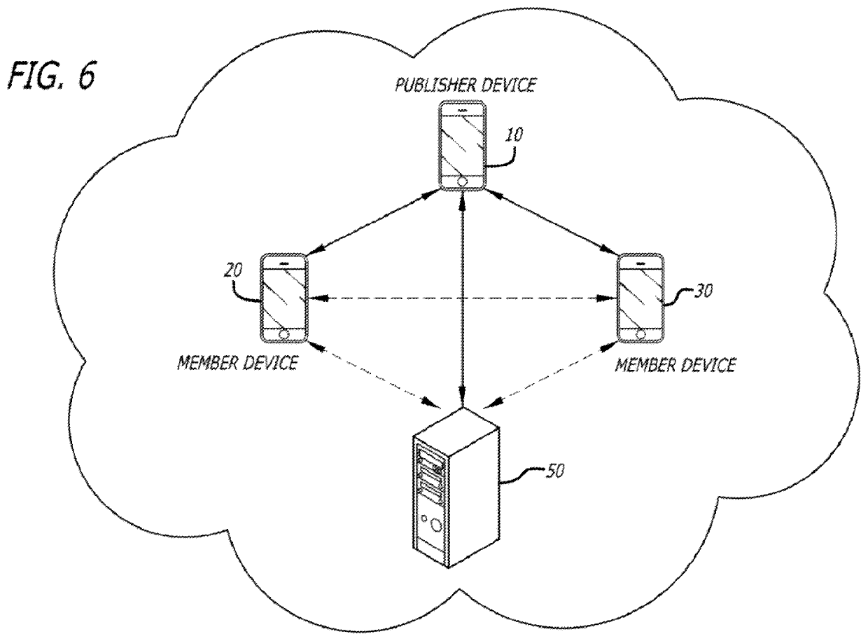

An example of such network formed after the members 20 and 30 install the applications and connect with the publisher 10, is shown in FIG. 6. This simplified illustration shows the member devices 20 and 30 along with the publisher device 10 and the accelerator server 50 forming a private cloud.

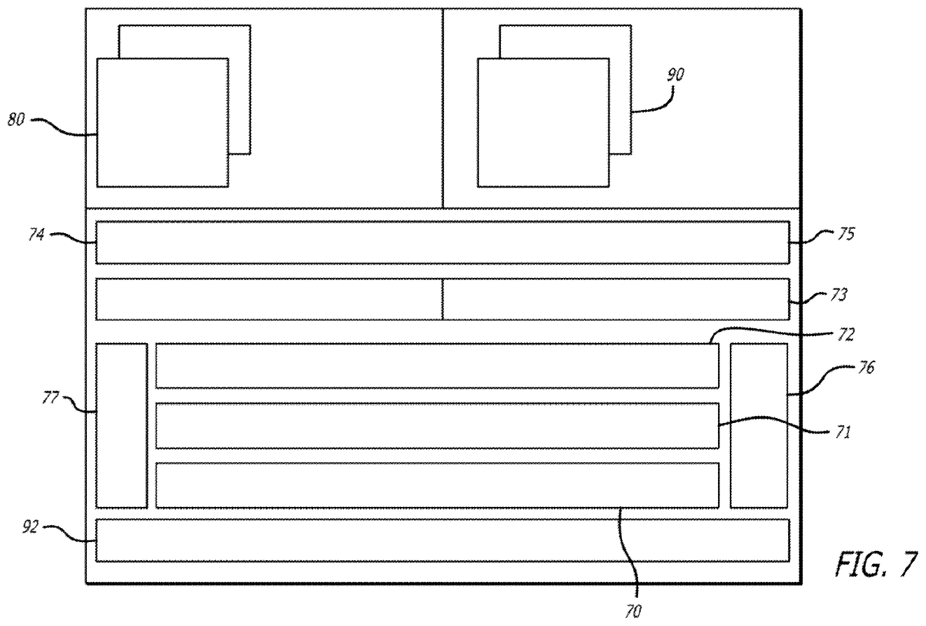

The microserver framework can be installed on a mobile device's operating system 92 and may have many components as shown in the block diagram of FIG. 7. Here, the install manager 70 of the microserver framework handles initialization, boot strapping, enrollment/reenrollment of devices among other things. The microserver data store function 71 manages data for each instance of the private circle. Further, it can handle replication and conflict resolution, as well as clean-up after a private circle has been de-provisioned. The micreoserver instance manager 72, manager can track all private circles and any authorized 3rd party applications 90. For instance a device may be connected to multiple private circles at a given time.

A public application programming interface (API) 73 may be included in some cases. When included, this API 73 supports the third party applications to permit access to the microserver framework. The private circle application (e.g. PriVapp) 74 utilizes the microserver framework for various functions for a private circle 80.

The microserver framework also provides a security manager 75 for establishing firewall, authentication, authorization, and encryption. Additionally, the mircroserver privilege function 72 can handle peering, back end server communication and secure SMS communication. Finally, the Configuration and administration user interface 77 can be used to manage the mircroserver features.

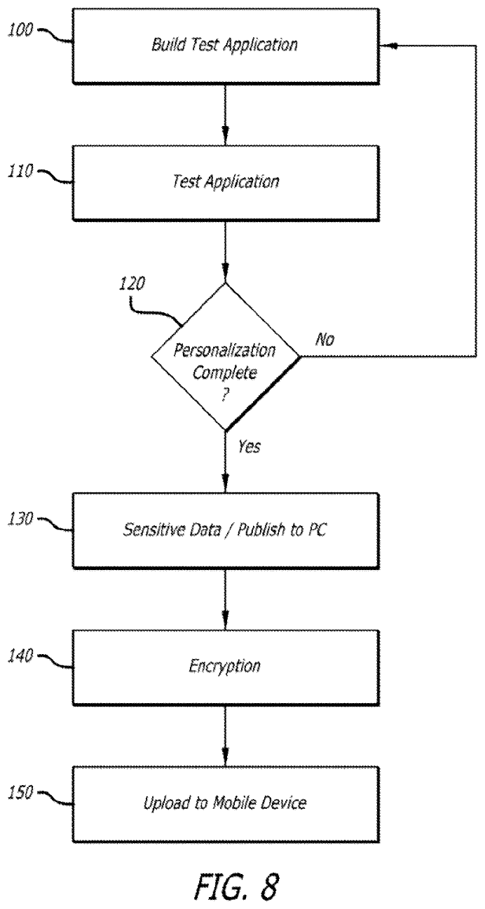

FIG. 8 provides a simplified flow chart showing the steps in using a private circle application to build a private circle. In step 100, a publisher selects from a list a suitable template and builds a test application. Upon further tweaking and testing the application in step 110, the publisher determines if the application requires additional personalization, per step 120. If further modification is needed, the publisher may further modify the application and upload additional branding and personalization. Once the personalization is complete, in step 130, the publisher downloads the application to his personal computer and includes sensitive information (member identification, address, etc.) for this private circle. Having already downloaded the microserver framework, the publisher encrypts the private circle data in step 140 and uploads the private circle application 150 to his mobile device.

The downloaded private circle application along with the data is shared with members in order build a private network as shown in the simplified flowchart of FIG. 9. Here, having downloaded the private circle application on a mobile device, the publisher sends an invitation 200 to members within this private circle. A member may then reply by confirming receipt 210 of the invitation. At this point, the member enrolls in the private circle by installing the microsever and private circle application per septs 220 and 230. The publisher then sends security keys 240 to the member device and after the keys are exchanged 240 the private connection is established between the devices.

### Working Examples

Working examples of some embodiments are provided in following section, without any intent to limit any particular embodiment. In these examples, the devices utilize a microserver framework called SoftServ™ and a private circle application called PriVapp™, both available at www.privapp.net. The device platforms in the following examples are iPhone® or iPad® devices, although the present embodiments is not limited so these devices and may utilize other operating systems.

### Example 1: Soccer Team Private Family Circle

Soccer Coach wants to run the school soccer season using PriVapp. To protect the private information of the team members, their families, team activities and locations. PriVapp is the one-stop application aggregating team information and communication. Using a laptop/desktop PC Coach goes to www.privapp.net and selects a template. Coach tweaks the, functions, layout and graphics until acceptable; then saves the template locally to PC hard drive. Having created an acceptable shell coach downloads the SoftServ microserver and sets up a preferred payment method. With the PriVapp shell downloaded, the Coach leaves www. PriVapp. net thus the Internet and the PriVapp now lives only on coach's local hard drive.

As a publisher, the Coach working locally, creates the list of the Team's circle of members who will later be invited to get the PriVapp. Using drag and drop of .vcf or other address book types as well as data entry, publisher populates the template with sensitive information: soccer team names, email addresses, phone numbers, caregiver, family and other relevant information. Using a sync cable, publisher connects mobile device, follows prompts and uploads the PriVapp mobile application to the SoftServ microserver previously downloaded from the Application Store.

With the PriVapp and SoftServ loaded on the mobile device, Publisher disconnects the sync cable. The PriVapp now lives exclusively on the Publisher's mobile device. For heightened security Publisher deletes that PriVapp from the desktop PC. The published PriVapp complete with sensitive information is now a freestanding functional application on the Publisher's device. With the team's circle of members already established, using SMS, the publisher now invites circle of members to join The Soccer Team PriVapp. SMS text links to a download SoftServ from the Application Store. Invitees download SoftServ, after which a text message “I got it” is sent back to Publisher. Using secure text embedded in SoftServ, Publisher sends to invited members: keys, handshake, authentication, etc. They are now securely connected. The secure tunnel has been established and the PriVapp can be passed on to members. Downloading may become easier as more Members join as the load is balanced across all qualified devices.

With the PriVapp circle established, publisher and members can now share may types of data including: scheduling, training, messaging, tasking/to do list, shared contacts, newsletters, announcements, exchange data, photos, games, community, player statistics of past games, statistical forecasts of upcoming matches, fantasy leagues and year-to-year metrics. Additionally, they may share alerts for canceled games, schedule and location of games, and parents can organize carpooling/pick-ups, determine MVP and track scores of season. The publisher (coach) is relieved from a great deal of cross-talk and tasks because the PriVapp facilitates those tasks allowing parents and players to handle such matters.

When the season is over, publisher may want to retain the PriVApp data for off-season training or next season. Alternatively the publisher may want to de-provision the Soccer Team PriVapp. Once de-provisioned, the Publisher does not have to pay for that PriVapp. De-provisioning invalidates the keys, and members are sent a secure SMS link informing that Soccer Team PriVapp is no longer in service and to remove the application from their device. SoftServ can remain on all devices to serve other PriVapps people may carry.

### Example 2: Pizza Restaurant Priority Customer Circle

Giorgio's Pizza wants to build an inner circle for its most favored core customers using a PriVapp circle called “Giorgio's Pizza Priority Customer PriVapp Circle.” It wants to give preferred customers priority access for backdoor ordering during peak times, special offers during slow times, and easy two-step ordering at all times. Order preference, delivery, payment information, names of family and ‘others that matter’ are all kept securely in Giorgio's Pizza Priority Customer PriVapp Circle. This circle is managed by the Publisher, accessed and used by the customer (member) with editing privileges.

With the Giorgio's PriVapp, core customers feel privileged with the special recognition and exclusive access. These features, may encourage customers to order more frequently to enjoy the shortened delivery times. Loyalty program tracking can offers for non-members the privilege of receiving an invitation to join the Giorgio's PriVapp upon earning a certain amount of loyalty points. Giorgio's staff is relieved from a great deal of noise and tasks because the PriVapp facilitates ordering, shorten phone hold times, and reduce lost business due to hang-ups/turned away phone calls. In particular, PriVapp orders could be routed to the ordering system and credit card information may be retained to facilitate order placement.

Using a laptop/desktop PC, Giorgio's goes to www. privapp. net and selects from the template library a template that has the functional features described above. Giorgio's enters all non-sensitive/public information such as Logo, menu, prices, etc. then tweaks functions, basic layout and graphics until acceptable; and saves the template locally to PC hard drive.

Having created an acceptable shell Giorgio's downloads the SoftServ microserver and sets-up their preferred PriVApp subscription payment method. With the PriVapp shell downloaded locally, Giorgio's leaves www. PriVapp. net and thus the Internet so that Giorgio's PriVapp now lives only on Giorgio's Pizza local hard drive.

Giorgio's Pizza as the publisher now populates the sensitive information fields for customers that will later be invited to the private circle. Giorgio's might use their ordering/accounting software to determine the top 300 families, then name, email, phone number, address(es), their typical order, the name(s) of who orders (Dad, Daughter, Sitter) or any information to that facilitates business between the business (publisher) and the customer (member).

Using a sync cable, Publisher connects mobile device, follows prompts and uploads the PriVapp Mobile Application to the SoftServ microserver previously downloaded from the Application Store. Publisher performs trial runs on connected device and when satisfied with features, updates the PriVapp on the device and unplugs the sync cable. The PriVapp now lives exclusively on the Publisher's device. For heightened security Publisher may then delete the previous copy of the PriVapp from the PC desktop.

The published Giorgio's Pizza Priority Customer PriVapp Circle complete with all information is now a freestanding functional application on the Publisher's device. Member previously identified can now be invited. Using SMS, publisher now “invites” circle of members to join Giorgio's PriVapp. SMS text links to a download SoftServ from the Application Store.

Invitees download SoftServ, after which a text message stating “I got it” is sent back to Publisher. Of course, those invited are not obligated to join. Using secure text embedded in SoftServ, Publisher sends to invited members: keys, handshake, authentication in order to establish a secured connection. The secure tunnel has been established and the PriVapp can be passed on to the invitees.

With the PriVapp circle established, Publisher and Members can now share data such as: ordering, texting, pick-up/delivery, specials, offers (ex. order by 6:00 pm for 20% off), newsletters and announcements. The publisher's ongoing management of the PriVapp data might best be handled on a tablet with a large viewable screen. With this type of PriVapp, the publisher should be careful about resynching with an unsecure local computer because of its vulnerability to hacking. Giorgios'may wish to update the customer list and details for each customer. For example, the publisher may add or drop members as well as update address, authorized household members, payment information, etc. for existing members.

Upon deprovisioning the PriVaipp, the publisher no longer will need to pay the subscription fee. At this point, the keys are invalidated and the members are sent a secure SMS link informing that Giorgio's Pizza PriVapp is no longer in service and to remove from their device. SoftServ can stay on all devices to serve other PriVapps.

### Example 3: Influencer in a Presidential Campaign Political Circle

In this example, the Campaign Influencer/Publisher wants to create an inside track at a national political party Convention using PriVapp. There could be a need to track and inform selected individuals of where to be and the activities of everyone else. Specifically, information may be about the candidates, special interest groups, the journalists as well as how to get in, how much money is being raised and from whom. Furthermore, the best parties, the names of staff, where to be and how to get in. Therefore, this example may be used as a tool to keep in the nexus of the convention and not be left out.

PriVapp can provide a dynamic calendar application, or may simply provide breaking or spontaneous information through a text/comment/chat posting. For this type of activity, PriVapp aggregates and protects campaign information, helping the circle stay organized, focused and able to securely communicate amongst them.

Using a laptop or desktop, a publisher goes to www. privapp. net and selects a template. He then tweaks the functions, layout and graphics then saves the template locally to PC hard drive. Having created an acceptable shell the publisher downloads the SoftServ micro-server and sets-up a preferred payment method. With the PriVapp shell downloaded, the publisher leaves www.PriVapp.net thus the Internet and the PriVapp now lives only on the publisher's local hard drive.

Working locally, Publisher now creates the list of the Circle of members who will later be invited to get the PriVapp. Using drag and drop of .vcf or other address book types as well as data entry, the publisher populates the template with sensitive information regarding the members.

Using a sync cable, Publisher connects mobile device, follows prompts and uploads the PriVapp Mobile Application to the SoftServ microserver previously downloaded from the Application Store. With the PriVapp and SoftServ loaded on the mobile device, Publisher disconnects the sync cable. The PriVapp now lives exclusively on the Publisher's mobile device.

For heightened security Publisher may then delete the previous copy of the PriVapp from the PC desktop. The published PriVapp complete with sensitive information is now a freestanding functional application on the Publisher's device.

Using SMS, Publisher now invites members to join the circle. Using PriVapp, the publisher sends an SMS text that links to ‘download SoftServ from the AppStore’. Those invited download SoftServ, and send a text message stating “I got it” back to Publisher's device. Using secure text embedded in SoftServ, Publisher sends to invited members: keys, handshake, authentication, etc. to securely connect. The tunnel has been established and the PriVapp can be passed on to the members.

With the PriVapp circle established, Publisher and Members can now share data: scheduling, events, messaging, tasking/to do list, shared contacts, daily hot list, announcements, updates, exchange data, photos, community data and candidate statistics. The publisher is able to create gravitas because he is more in-the-know and others will want join the Circle in order to benefit from the inside track.

When the Convention is over, Publisher may want to retain the PriVApp data for next time Or de-provision the PriVapp. Once de-provisioned the Publisher does not have to pay the subscription fee as deprovisioning invalidates the keys. The members are also sent a secure SMS link informing them that PriVapp is no longer in service and advising that they remove it from their device. SoftServ can stay on all devices to serve other PriVapps people may carry or publish.

### Example 4: Medical Circle

A Physician or patient may sets up a PriVapp Medical Circle private network between primary care provider, patient, authorized patient representatives, and referred medical providers to capture and share the complete patient medical record including historical information and referral information and lab results all in a secure and HIPAA compliant manner. This particular PriVapp Circle may in some cases be as small as two individuals, the patient and the medical professional. The publisher may set up this private circle in the same or similar manner provided in examples 1-3 above.

### Example 5: Government Emergency and Disaster Circle

It can be beneficial for government officials or agencies to communicate directly and privately with others agencies regarding urgent matters. In this example, members of the Disaster and Emergency Services department can have SoftServ and an unpopulated PriVApp already installed on their devices. At the onset of, for example, an earthquake epicenter in town of Napa Calif., Disaster Preparedness Coordinator who is the Publisher of this PriVapp circle can the PriVapp allowing for members to connect immediately. The CA Emergency Management Agency and FEMA Governor's Office of Emergency Management will then be connected on this PriVapp circle. Of course other entities may be added to this circle by the publisher if for example a certain agency needs to participate in the activities of this private circle. This PriVapp can also be set up in a manner similar to those in examples 1-3.

While the foregoing written description of the embodiments enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method for providing secure access to a closed mesh network, comprising:
Embedding a QR code into a physical carrier object;
Scanning the QR code with a camera-equipped device;
Extracting, from the QR code, an access credential, configuration profile, or secure URL;
Using the extracted information to automatically configure the device for secure network access;
Authenticating the device with the mesh network based on the credential;
Establishing end-to-end encryption between network nodes without manual credential entry.

2. The method of claim 1, further comprising generating access credentials with cryptographic randomness ensuring they are single-use or time-limited.

3. The method of claim 1, wherein the QR code is covertly embedded in an object selected from an adhesive bandage, photograph, or ID card.

4. The method of claim 1, wherein the QR code encodes a VPN, WireGuard, or proprietary mesh network configuration profile.

5. The method of claim 1, further comprising initiating a secure messaging application, encrypted voice/video session, or data transfer upon network onboarding.

6. The method of claim 1, wherein the authentication is performed without transmitting plaintext credentials over any insecure channel.

7. The method of claim 1, wherein the onboarding process is completed in less than five seconds following scanning of the QR code.

8. The method of claim 1, wherein each QR code scan event is logged for auditability and compliance tracking.

9. The method of claim 1, wherein the QR code is overtly displayed on the object to facilitate user awareness.

10. The method of claim 1, wherein the method supports rapid onboarding for emergency or covert deployment scenarios.

11. The method of claim 1, wherein the mesh network recognizes and authenticates new nodes using the authenticated credential received from the scanned QR code.

12. The method of claim 1, further comprising temporarily granting network access upon credential expiration.

13. The method of claim 1, wherein network access is revoked if audit logs indicate unauthorized activity following QR code onboarding.

14. The method of claim 1, wherein the QR code is distributed in a physical form suited for disaster response or first responder use cases.

15. The method of claim 1, wherein access credentials encoded in the QR code are periodically refreshed to prevent replay attacks.

16. The method of claim 1, wherein the secure communications initiated during onboarding include real-time encrypted video transmission between network nodes.

17. The method of claim 1, wherein the configuration profile extracted from the QR code specifies channel, bandwidth, and encryption parameters for the mesh network.

18. The method of claim 1, wherein onboarding includes multi-factor authentication by combining QR code scanning with biometric or PIN verification.

19. The method of claim 1, wherein the physical carrier object containing the QR code is designed for durability and environmental resistance.

20. The method of claim 1, wherein the QR code is rendered unreadable or non-functional following successful onboarding to prevent credential reuse
